(19) United States
(12) Patent Application Publication
(10) Pub. No.: US 2025/0121418 A1
(43) Pub. Date: Apr. 17, 2025

(54) DELAMINATION OF PHOTOVOLTAIC MODULE FOR RECYCLING

(71) Applicant: SOLARCYCLE, Inc., Mesa, AZ (US)

(72) Inventors: Pablo RIBEIRO DIAS, Mesa, AZ (US); Egnaldo Guimaraes DA SILVA NETO, Porto Alegre (BR); Lucas Margarezzi SCHMIDT, Porto Alegre (BR); Felippe Stefanowski KERPEN, Porto Alegre (BR)

(21) Appl. No.: 18/913,177

(22) Filed: Oct. 11, 2024

Related U.S. Application Data
(60) Provisional application No. 63/590,214, filed on Oct. 13, 2023.
(60) Provisional application No. 63/590,221, filed on Oct. 13, 2023.
(60) Provisional application No. 63/590,229, filed on Oct. 13, 2023.

(51) Int. Cl. B09B 3/35; B09B 3/40; B09B 3/70; B09B 3/80; B09B 101/15; B09B 101/50

(52) U.S. Cl. CPC B09B 3/35; B09B 3/40; B09B 3/70; B09B 3/80; B09B 2101/15; B09B 2101/50

(57) ABSTRACT

A variety of techniques, performed alone or in various combination(s), may be employed to process used solar modules for disposal and/or recycling. Particular embodiments may leverage weaker adhesion between internal layers of a used module, than between internal layer(s) of the used module adhered to glass (e.g., front and/or back glass sheets). This difference in adhesive strength may allow the application of mechanical energy for delamination. Embodiments may also apply temperature change in the service of delamination. Specific embodiments may involve chemical processing in the form of leaching for the recovery of material. Certain embodiments may introduce chemical reactant(s) and/or solvents (e.g., under pressure) in the form of fluid(s) to permeate through polymeric layers of a module and reach solar module internal module layers formed by vapor deposition. Some embodiments may be particularly suited to the recycling of used CdTe solar modules.

### CROSS-REFERENCE TO RELATED APPLICATIONS

The instant nonprovisional patent application claims priority to each of the following US Provisional patent applications, all of which were filed on Oct. 13, 2023:
U.S. Provisional Patent Application No. 63/590,214;
U.S. Provisional Patent Application No. 63/590,221; and
U.S. Provisional Patent Application No. 63/590,229.

Each of these provisional patent applications is incorporated by reference herein for all purposes.

### BACKGROUND

As world population increases, the earth is subjected to escalating environmental stress. One form of stress is manifest in rising global temperatures attributable to the burning of fossil fuels in order to provide energy needs.

Alternative energy sources can provide power, while lessening the carbon dioxide burden on the planet. One important source of alternative energy is solar power.

Solar modules are complex manufactured items. They harness the sun's energy and convert it into a usable energy source for residential, commercial and utility-scale applications. As the climate has been significantly impacted by the use of fossil fuels over the past century, the need for alternative sources of energy like solar has taken on greater importance.

Another form of environmental stress imposed upon the earth, is the accumulation and disposal of waste products from human activity. Accordingly, rather than discarding a solar module at the end of its lifetime, it may be desirable to recycle material(s) from a solar module for reuse and thereby avoid deposition in a landfill.

### SUMMARY

A variety of techniques, performed alone or in various combination(s), may be employed to process used photovoltaic modules for disposal and/or recycling. Particular embodiments may leverage weaker adhesion between internal layers of a used module, than the adhesion between internal layer(s) and glass of the module (e.g., front and/or back glass sheets). This difference in adhesive strength may allow the application of mechanical energy for delamination. Embodiments may also apply temperature change in the service of delamination. Specific embodiments may involve chemical processing in the form of leaching for the recovery of material. Certain embodiments may introduce chemical reactant(s) and/or solvents (e.g., under pressure) in the form of fluid(s) to permeate through polymeric layers of a module and reach solar module internal module layers formed by vapor deposition. Some embodiments may be particularly suited to the recycling of used CdTe photovoltaic modules.

### BRIEF DESCRIPTION OF THE DRAWINGS

FIG. 1 shows a cross-sectional view of a monofacial solar module.

FIG. 1A shows a simplified overhead view of the laminate of a solar module, lacking the frame and the top transparent sheet.

FIG. 1B shows a simplified view of a solar module having a thin film structure, with frame and junction box(es) removed.

FIG. 2 shows a wire used to cut through one or more layers of a PV laminate.

FIG. 3A shows a cleaving process using a spatula.

FIG. 3B shows a piece of panel still with both glasses and glass cullet removed.

FIG. 3C shows an enlarged view of the cullet removed.

FIG. 4A shows a side view of a shear experiment with 40° force angle. FIG. 4B shows an enlarged view.

FIG. 5 shows side view of an experiment with mechanical stress applied in the form of a parallel shear force.

FIGS. 6 and 7 show results of numerical modeling, and in particular Von Mises stress distribution.

FIG. 8A shows a cross-section of the CdTe laminate.

FIG. 8B shows an overhead view of an embodiment of an apparatus for applying a shear force for delamination, with the cavity unoccupied and including a blade.

FIG. 8C shows a cross-sectional view of the apparatus of FIG. 8B.

FIG. 8D shows an enlarged cross-sectional view of the cavity defined within the bipartite device.

FIG. 8E shows an enlarged view of the blade tip encountering the thin film(s) located between the glass of the bottom side and the glass of top (solar) side of the laminate.

FIG. 9 shows a simplified view of such a scraper according to an embodiment.

FIG. 10A displays an embodiment of an apparatus for use in delamination, where

a frame could be removed as glass layers are separated.

FIG. 10B shows as the assembly is moved to the left, a thin blade cleaves the laminate.

FIGS. 11 and 12 show up and down movements of members accommodating different module types for delamination.

FIG. 13 shows the members actuated in the same direction.

FIG. 14 plots Cd content over time

FIG. 15 plots Te content over time, using Piranha solution under different sulfuric acid concentrations.

FIG. 16 plots Inductively Coupled Plasma-Optical Emission Spectrometry (ICP-OES) results for Cadmium using Piranha solution under Piranha solution.

FIG. 17 shows CdTe Chemical leaching results for the reuse of the piranha solution, rinsing with water and leaching effectiveness.

FIG. 18 shows Cadmium and Tellurium content evaluated in a leaching process.

FIG. 19 is a table showing results of analysis via ion chromatography.

FIG. 20 is a table showing hazardous waste toxicity definitions for eight metals.

FIG. 21 shows requirements for wastewater discharge compliance concentrations by the city of Phoenix, Arizona.

FIG. 22 presents a list of discharge limits (in mg/L) for metal species.

FIG. 23 is a table showing samples collected in various pH's.

FIG. 24 is a table showing precipitation effectiveness in piranha.

FIG. 25 is a table showing precipitation effectiveness in rinsing water.

FIG. 26 is a table showing precipitation effectiveness in a mixture of piranha and rising water.

FIG. 27 is a table showing precipitate per liter of piranha+rinsing water mix.

FIG. 28 shows total cadmium and tellurium recovered by each step of the process.

FIG. 29 shows Cadmium and tellurium content evaluated in a leaching process.

FIG. 30 shows granulometric distribution of a manually comminuted sample.

FIG. 31 shows an embodiment of a showering device.

FIG. 32 shows Cadmium and tellurium content evaluated in a leaching process.

FIG. 33 shows cadmium and leached tellurium recovered.

FIG. 34 is a table showing results of precipitation with KOH until pH 8.5-9.

FIG. 35 is a table showing pH and temperature conditions for KOH precipitation.

FIG. 36 describes experiments with different precipitation agents.

FIG. 37 plots Particle Size Distribution (PSD) of samples leached and rinsed.

FIG. 38 is a table showing Cadmium and tellurium content evaluated in steps of the leaching process and effectiveness.

FIGS. 39A-39C show a simplified flow diagram illustrating a process flow involving both mechanical and chemical processing.

FIG. 40 shows a simplified view of a laminate including encapsulant.

FIG. 40A shows a simplified view of fluid(s) reaching internal layer(s).

FIG. 40B shows removal of vapor deposited layers separating a laminate into components.

FIG. 41 shows a simplified view of an apparatus according to an embodiment, that is configured to perform delamination.

### DESCRIPTION

Solar modules exist in a variety of types and architectures. Examples of such modules can include but are not limited to:
Monocrystalline Solar Panels (Mono-Si)
Polycrystalline Solar Panels (p-Si)
Amorphous Silicon Solar Panels (a-Si)
Cadmium telluride photovoltaics (CdTe)
Copper indium gallium selenide modules (CIGS)
Copper indium selenide modules (CIS)
Concentrated PV Cell (CVP)
Biohybrid Solar modules
Monofacial modules
Bifacial modules
Modules without encapsulant
Silicon heterojunction solar modules
tunnel oxide passivated contact solar modules (TOPCON)
passivated emitter and rear contact solar modules (PERC)
Tandem-junction Solar Panels
Perovskite-based Solar Panels
Glass-Backsheet Solar Panels
Glass-Glass Solar Panels
Building-Integrated Solar Panels
Polymer-Based Solar Panels
Solar Roof Tiles
Solar Roof Shingles

Solar modules can last decades, with some degradation in performance over a module's lifetime. Also, solar modules that have been deployed on residential rooftops and other commercial and utility-scale applications for a number of years, may be decommissioned for a variety of reasons.

For example, (residential, commercial, utility) users of solar panels may desire to exchange their modules for newer, higher performing modules in order to maximize the amount of energy obtained from a solar array.

As more solar modules reach the end of their useful lives and/or are relinquished by their owners, it is desirable to dispose of the panels in an environmentally-friendly and economically-feasible way. Alternatively, it may be desired to refurbish and reuse existing solar modules to prolong their lifetimes and reduce cost.

Once it is determined that a solar module is no longer useful to its owner, e.g.:
the module has reached the end of its current deployment due to non- or underperformance,
the module has been damaged in transit, or
for other (e.g., economic) reasons,
   in order to avoid discarding the module into a landfill, the module may either be recycled or refurbished and reused.

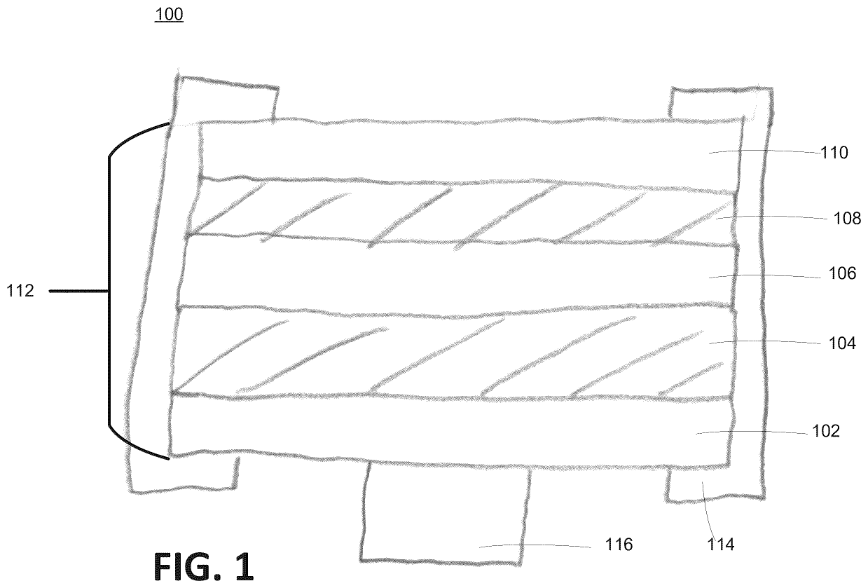

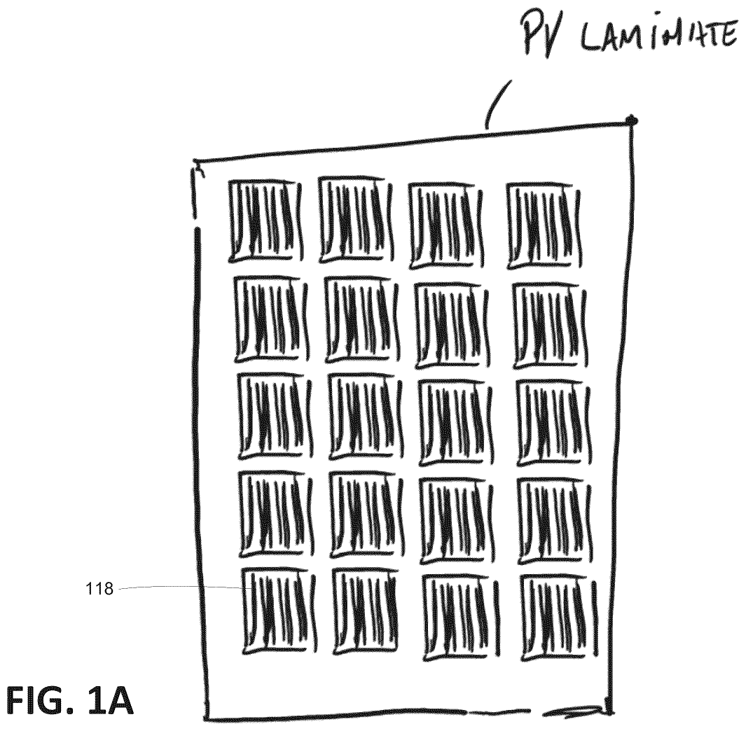

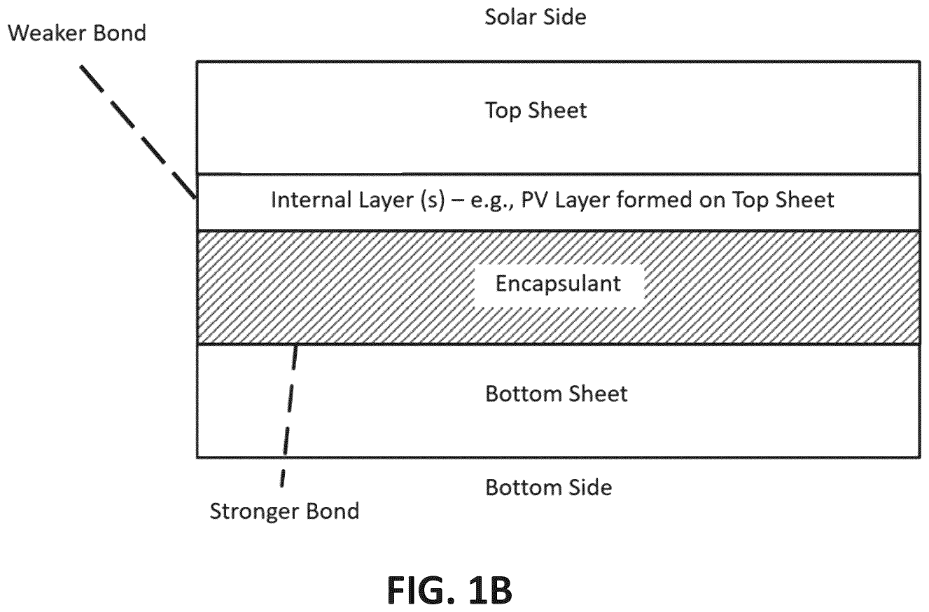

FIG. 1 shows a cross-sectional view of a monofacial solar module in an example.

The PV module 100 is made of different layers assembled into the structure shown in FIG. 1. These layers of FIG. 1 are not drawn to scale.

The layers of FIG. 1 can be simplified as:
substrate (backsheet or glass sheet) 102,
back encapsulant 104, e.g., Ethylene-vinyl acetate (EVA), silicone, Polyvinyl butyral (PVB), IONOMER,
solar cell 106 comprising PV material (including, e.g., but not limited to: doped single crystal, polycrystalline, or amorphous silicon, Group III-V materials) and metallization,
front encapsulant 108,
transparent front cover sheet 110 (e.g., typically glass).
   This grouping of layers is referred to as a laminate 112.

It is further noted that bifacial modules also exist. Such bifacial modules may exhibit a structure similar to that of FIG. 1, but have a transparent (e.g., glass) layer instead of a backsheet layer. This allows (e.g., reflected) light to enter the module from the back.

The laminate in FIG. 1 is surrounded by a frame 114. The frame may comprise a stiff metal such as aluminum. Alternatively, a frame material may be plastic, comprising e.g., polycarbonate.

A junction box 116 is also part of the module. The junction box may be potted (more common in newer models) or non-potted (more common in older models). In a potted PV junction box, the foils coming out of the solar panel are soldered to the diodes in the junction box, and the junction box is potted or filled with a type of sticky material to allow thermal transfer of heat to keep the solder joint in place and prevent it from falling. Fabrication may take longer but creates a better seal.

In the non-potted PV junction box, a clamping mechanism is used to attach the foil to the wires in the junction box. This can involve a faster assembly, but may not be as robust.

FIG. 1A shows a simplified overhead view of the laminate of a solar module, lacking the frame and the top transparent sheet. FIG. 1A shows solar cells including patterned metallization 118, which may comprise, e.g., a valuable metal such as silver.

Solar modules can have a variety of structures, including but not limited to:
Concentrated PV Cell (CVP)
Biohybrid Solar modules
Monofacial modules
Bifacial modules
Modules without encapsulant
Silicon heterojunction solar modules
tunnel oxide passivated contact solar modules (TOPCON)
passivated emitter and rear contact solar modules (PERC)
Tandem-junction Solar Panels
Perovskite-based Solar Panels
Glass-Backsheet Solar Panels
Glass-Glass Solar Panels
Building-Integrated Solar Panels.
Polymer-Based Solar Panels
Solar Roof Tiles.
Solar Roof Shingle

Certain types of solar modules use silicon as a semiconductor responsible for converting sunlight into electrical energy. Particular solar module types may utilize a thin film structure. FIG. 1B shows a simplified view of a solar module having a thin film structure, with frame and junction box(es) removed.

Thin film modules can be made with internal layers of materials other than silicon acting as semiconductors. One form of thin film module utilizes Cadmium Telluride (CdTe) as a photovoltaic material. Other examples of thin film panels include those with Amorphous silicon (a-Si), Multijunction cells (a-Si-μc Si), Copper indium gallium diselenide (CIGS) and copper indium diselenide (CIS).

CdTe modules may have additional materials in the thin film structure in addition to CdTe. Examples of such other materials can include but are not limited to Selenium, Zinc, ZnTe, and others. Thin film solar modules (such as CdTe) often include photovoltaic material sandwiched by two glass sheets.

A semiconductor comprising CdTe is located between the glass sheets of the solar side and the bottom side. Other internal layers may comprise one or more of:
encapsulant,
rear conductors (generally metals such as copper),
insulators,
transparent conducting layer (or transparent conducting oxide—TCO),
buffer layer(s) generally located between the top/solar glass and transparent conducting layer.

Internal layers may be isolated from the exterior of the module, which can offer harsh temperature and moisture (e.g., snow, rain, humidity) conditions. The outer structure of a module can feature a metal (e.g., aluminum or steel) frame for support. Other module types may lack a frame.

One or multiple junction boxes are placed on the outer part of the panel (e.g., on the bottom glass), in order to allow leads to conduct electric current.

Embodiments relate to delamination of used thin film solar modules that promote the recovery of materials. Methods and apparatuses for exposing the internal layers and later recovering the materials of interest are now described.

Module delamination according to embodiments may be aided by the use of temperatures higher than ambient temperature. Temperatures between about 80-90° C. can work well.

Embodiments assist and enhance the recycling process by exposing the internal layers of a thin film panel via delamination. As described in detail below, such delamination may result from the application of mechanical energy (which may be in the form of shear force) and/or thermal energy.

Embodiments may leverage the fact that internal layers of the used module may adhere more weakly to each other, than to the glass sheets. For example, weaker bonds may be those between the internal layers themselves (e.g., between the absorber layer and the back contact layer, or between back contact layer and the rear conductor, or between the TCO layer and the absorber layer). Stronger bonds may be those between glass and whatever glass is touching. Some of these bonds (e.g., stronger and/or weaker) may not be primary in nature (e.g., covalent), but rather secondary.

Encapsulant may or may not comprise one of the internal layers of the used solar module that is being delaminated. However, embodiments lacking encapsulant may rely upon the reduced strength of adhesion between other internal layers (as compared with the strength of adhesion between internal layers and glass) in order to accomplish delamination.

If the used module originally has its glass intact (i.e., not broken), delamination according to embodiments may result in two separate glass sheets and thus create two new faces. In particular, prior to delamination there may be only two faces: the back and the front of the panel. Following separation of full sheets by delamination, four faces may be present. One or more of these faces may include internal layers of the thin film panel.

If the glass is not originally intact, delamination according to embodiments can still be performed. Instead of producing two separate glass sheets, two groups of glass cullet may result. One cullet group originates from the bottom sheet bearing the internal layers, while the other cullet group is from the top sheet.

### EXAMPLES

Specific examples are now discussed. Here, thin film photovoltaic modules comprising at least an internal layer comprising a thin film semiconductor sandwiched between top (solar) glass and bottom glass layers, were delaminated. In some cases, the thin film semiconductor material was CdTe.

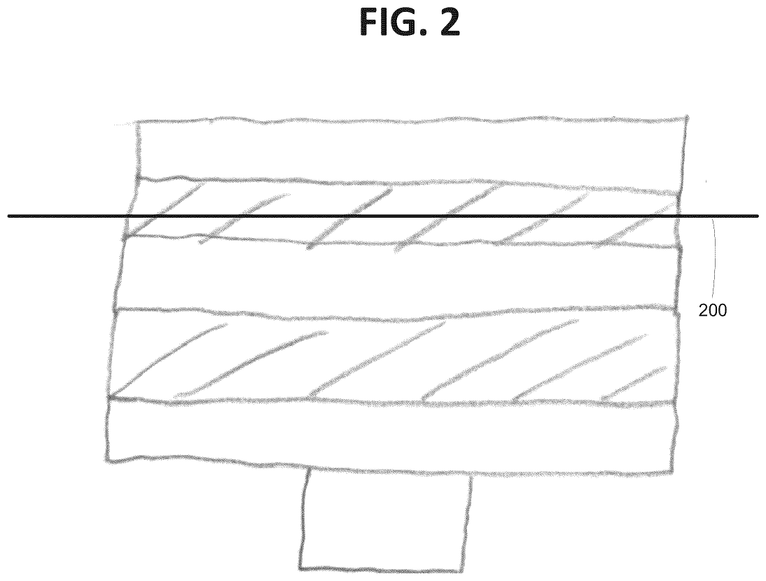

According to certain embodiments, delamination may be accomplished using a wire. Prior to delamination, the frame is removed. Then, as shown in FIG. 2, according to embodiments a thin wire 200 may be used to cut through one or more layers (e.g., front encapsulant, back encapsulant, both front and back encapsulant, backsheet) of the PV laminate.

In some embodiments, the wire may be heated to temperatures of between about 400-600° C. For particular embodiments, this can be achieved by applying a difference of electric potential between the two ends of the wire.

The heated wire can then be pushed through encapsulant layer(s). This effectively separates the laminate into different parts.

According to some embodiments, the heat of the wire effectively degrades (“melts+burns”) the encapsulant. In certain embodiments, the wire physically cuts through the encapsulant material. The encapsulant material may be merely softened to allow passage of the wire.

In particular embodiments, the wire may have a diameter of 0.5 mm or less. Specific embodiments may employ a wire having a diameter of between about 0.2-0.5 mm.

A wire material useful for embodiments, may exhibit high mechanical strength and sufficiently low electrical conductivity to generate the heat by resistive heating. Examples of possible candidates for wire materials include but are not limited to:
NiCr alloy,
stainless steel,
FeCrAl alloy,
aluminum (such as 6000 series),
copper coated materials.

Delamination according to particular embodiments, may separate the top (e.g., glass) sheet and the rest of the layers. For some embodiments, the delamination process could separate the laminate into three (3) distinct layers: the top sheet (e.g., glass), the solar cell, and the backsheet. For some embodiments, the delamination process could separate the laminate from the backsheet.

Embodiments may determine where pressure is specifically to be applied as part of a delamination process. For example, embodiments may determine a location as to where the wire should engage with the module.

One possible approach to targeting a location of application of the hot wire may be based upon optics. That is, differences in refraction index of cover sheet (e.g., glass) versus encapsulant (e.g., EVA) may be detected.

Another possible approach to wire targeting may be based upon X-Ray Diffraction (DRX). One example could detect an amorphous structure of a glass cover sheet, versus a semi-crystalline structure of EVA.

One possible approach to wire targeting, is to have the wire push against the glass as to create an angle between 5-45° from the panel inclination. Exerting a force down on the wire can serve to keep the panel flat during processing.

For some embodiments, data relating to factors including but not limited to:
panel size,
panel model, and/or
panel weight,
   could be stored in a database that is in turn referenced to output a thickness of the glass. The laminate could be aligned relating the model, manufacturer, and/or year to a database.

Use of a hot wire for delamination according to embodiments may offer one or more benefits. A first benefit is low energy use to heat up the wire. Another possible benefit is precise application of the wire to the laminate, resulting in clean separation of the layers.

It is noted that the use of a heated wire is not required. Certain embodiments may employ a wire cutting technique (e.g. unheated diamond wire cutting) to separate the layers from each other. A diamond wire may be lubricated and cooled with oil and water.

Delamination approaches according to embodiments are not limited to cutting using a wire. In specific embodiments, a thin (e.g., 0.05-0.5 mm) sheet of material could be used. Such a sheet of material could comprise, e.g., steel, cast iron, aluminum, titanium alloys, tungsten alloys. Embodiments could utilize a sheet of composite material for cutting (e.g., with carbon fiber or glass fiber) or a ceramic sheet (e.g. alumina, which is aluminum oxide).

In some examples, thermal delamination may be achieved. Subjecting the used modules to high temperatures (e.g., between about 300-700° C.; between about 400-600° C.; between about 520-570° C.) can also be effective in separating the two glass sheets.

Encapsulant within the panel may become degraded and removed. This leaves behind sheets of glass (or groups) which can then be sorted.

In particular embodiments, this thermal delamination process can be achieved by putting the panels in a furnace powered by fossil fuels or electricity. Electricity can come from renewable energy or fossil fuels. Renewable energy can include that harvested by used solar panels.

In some embodiments, used modules can be placed in the furnace as a laminate. In other embodiments, modules can be placed into the furnace with only the cables and the junction box removed, but still including the frames.

Embodiments are not limited to using a furnace to apply thermal energy. Other methods of heating up the module may be to apply one or more of:
microwave radiation;
infrared radiation;
radiation from a laser—e.g., focused on encapsulant layer(s).

The thermal delamination process may does not require a special atmosphere. Certain embodiments may be performed under ambient conditions.

Delamination in accordance with some embodiments may utilize mechanical cleaving. The sandwich structure of a module may be fabricated, such that different layers are kept attached to each other over long periods of time as modules are exposed to the weather in the field during operation.

However, the attraction force between various layers of the laminate may not be particularly strong from a mechanical standpoint. Thus, the use of a cleaving device designed to overcome certain bond forces—e.g., between a top sheet and underlying internal layers-while not overcoming other bond forces—e.g., between a bottom sheet and internal layers (for example, as may have previously been formed thereon), could be used for delamination according to embodiments. Apparatuses according to some embodiments may feature an edge sufficiently thin to be introduced between the two layers of glass, to cleave the sandwich structure.

One resulting glass sheet may have some encapsulant (polymer) contamination. The other resulting glass sheet may include internal layers, and may be processed further for material separation, recovery, and/or purification. Such post-delamination techniques are described later below.

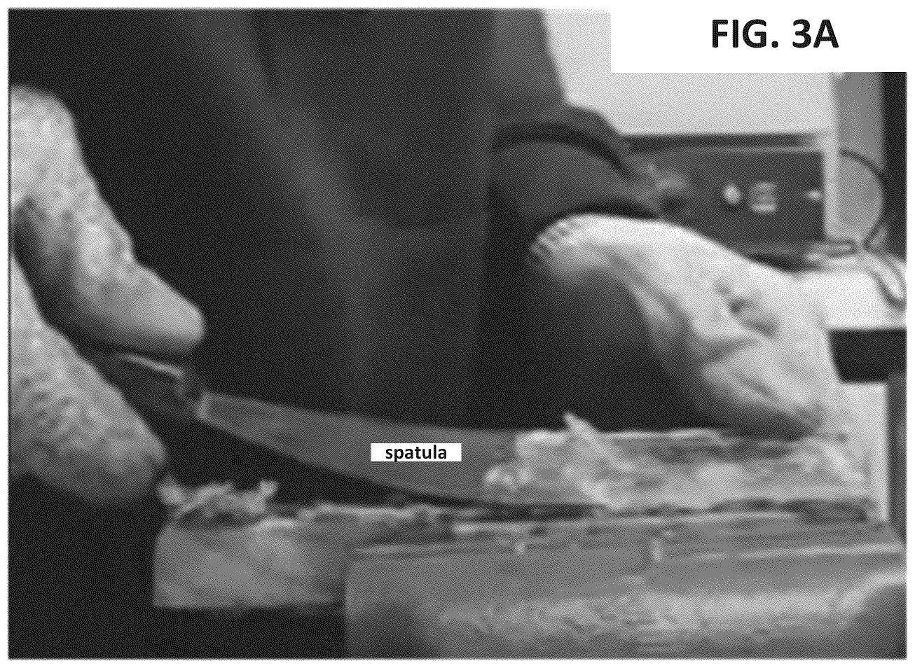

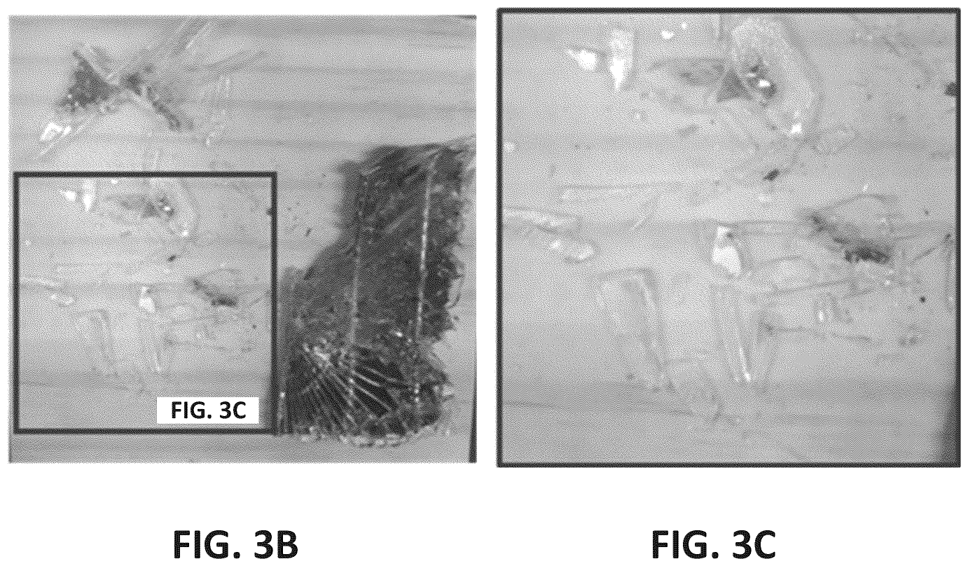

FIG. 3A shows a cleaving process using a spatula. FIG. 3B shows a piece of panel still with both glasses and glass cullet removed.

FIG. 3C shows an enlarged view of the cullet removed. Some cullet lack apparent contamination, while others include contamination.

The spatula was used to cleave the following three samples through the glass/semiconductor interface:
sample 1: at room temperature;
sample 2: heated by infra-red light at 80-90° C.;
sample 3: heated by infra-red light at 100-120° C.

At room temperature, it was difficult to cleave without damaging the semiconductor layer. With temperatures between 80 and 90° C., the spatula could easily advance between the layers.

Higher temperatures up to 120° C. made the process more complicated. In those cases, small pieces of semiconductor may get stuck in the removed cullet.

During relative displacement of the cleaving, buckling may occur. Buckling can be contained in order to prevent the semiconductor from breaking. Delamination may be accomplished using a hammer. Prior to delamination, the frame may be removed.

Then, a (rubber) hammer may be used to remove the front glass cullets by hammering the back glass of the CdTe panel. The adhesive force between the back glass and the encapsulant keeps the back glass intact with part of the semiconductors.

The front glass with the other part of semiconductors are removed in forms of cullets.

This process is able to expose the semiconductors (e.g., for chemical leaching) without the use of prior milling processes. The benefits may be the reduction of the cost (as milling can be expensive) and the minimization of the formation of fine particles.

Certain embodiments may perform a controlled fracture using suction. Fracturing the laminate on an appropriate side (i.e., the side of the encapsulant where the encapsulant and glass interface) can be employed.

Forces attaching these (undeposited) glass pieces to the laminate are relatively weak, possibly allowing clean removal of cullet by hand. A vacuum system can be used to secure one side of the laminate and/or pull on side(s) of the laminate and thereby release the glass pieces from the surface that has been fractured.

According to particular embodiments, shearing may be used to accomplish delamination. Some embodiments may involve attaching both surfaces of the panel to an apparatus (e.g., at an angle). This attachment may be accomplished using an adhesive.

Then, shear stress is applied to allow the planes to slide on each other. The result is the separation of the two faces. In certain embodiments, angles of 45°, 40°, and 30° may be successful.

In one test, two directions were used to apply the shear into the ethylene vinyl acetate (EVA) encapsulant with resultant force:
1) parallel to the plane; and
2) at an angle of 40°.

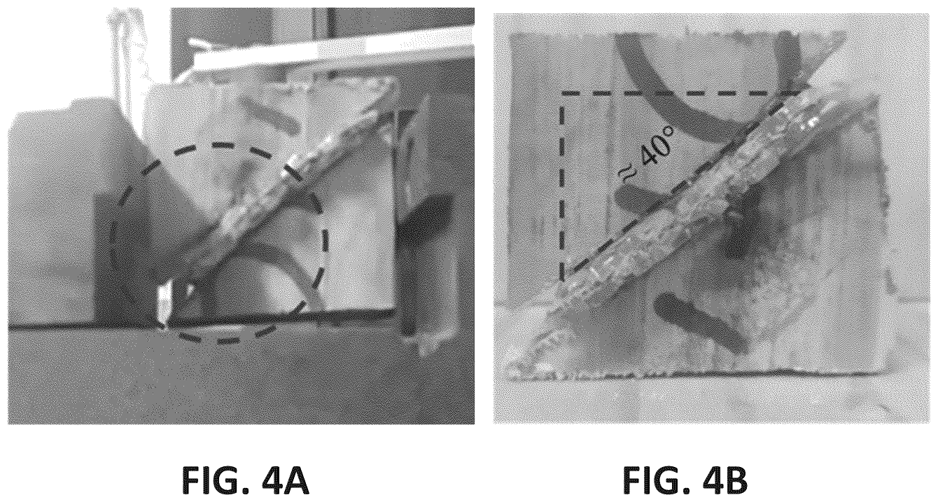

FIG. 4A shows a side view of a shear experiment with 40° force angle. FIG. 4B shows an enlarged view.

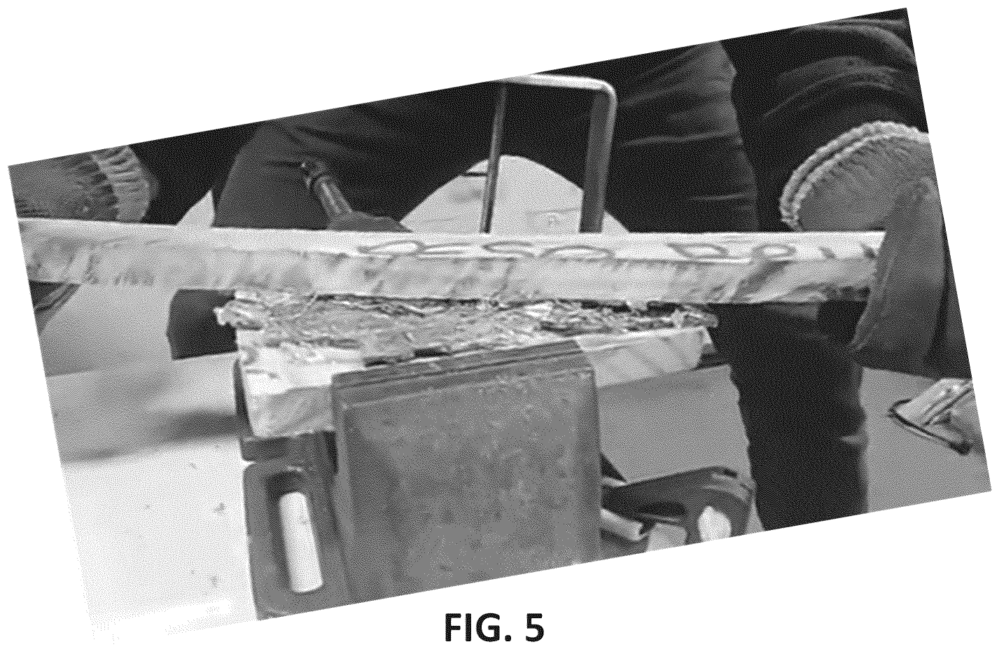

FIG. 5 shows side view of an experiment with mechanical stress applied in the form of a parallel shear force. In both cases, samples were heated with infra-red light until reaching temperatures between about 100-120° C.

It was observed that only the regions embedded by the adhesive were removed. This indicates that the cullet may not be capable of transmitting the force, and instead push the adjacent ones.

In other words, it may be necessary to cover the whole surface in order to completely remove the glass. This result is valid for the current sample sizes.

The experiment performed with the force coming parallel from the side (FIG. 5) had that sample heated in the microwave. Instead of removing only the glass layer, the applied force broke the samples into even smaller pieces. This outcome may be due to the dimensions of the device.

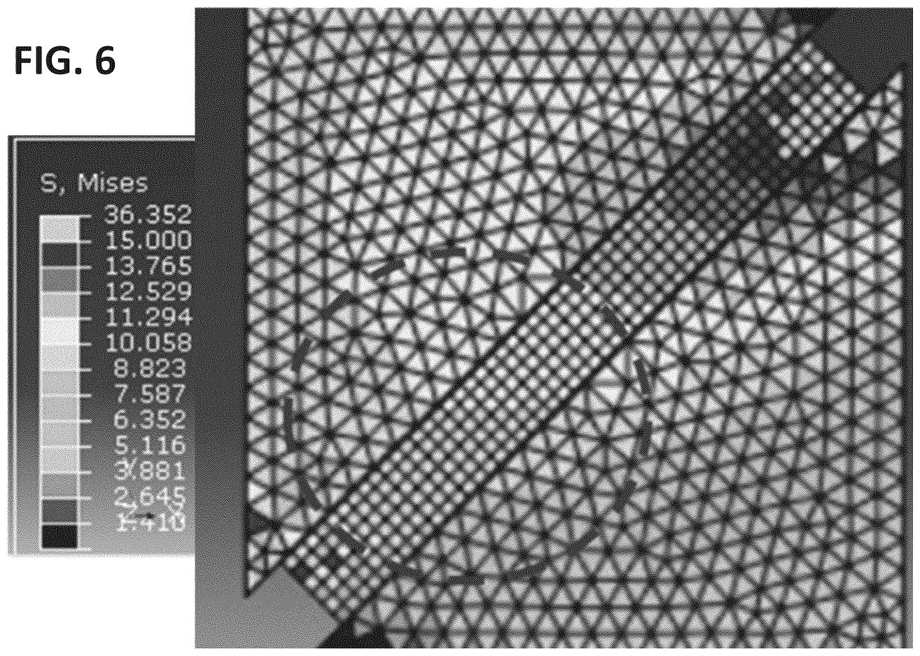

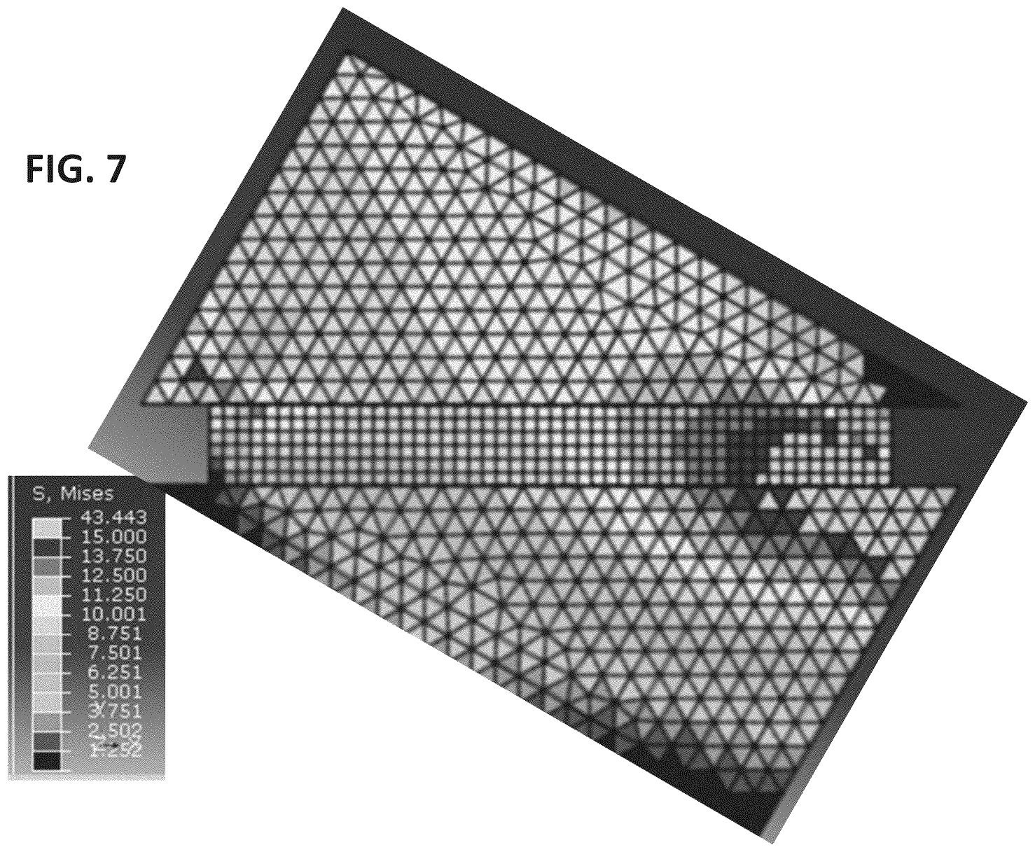

FIGS. 6 and 7 show the results of numerical modeling, and in particular Von Mises stress distribution. The numerical model showed a stress distribution along the adhesive interface similar for shear force applied parallel, and at an angle.

The region along the interface (as displayed inside the dashed circle in FIG. 4A) had lower stresses level compared to other regions. Delamination caused by shear forces appeared to start at this location.

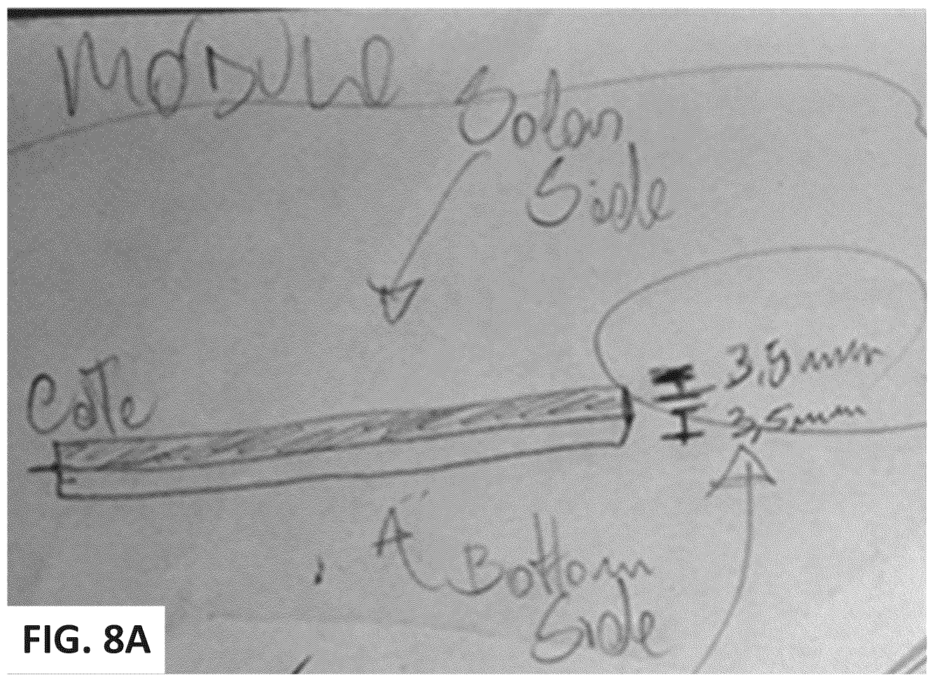

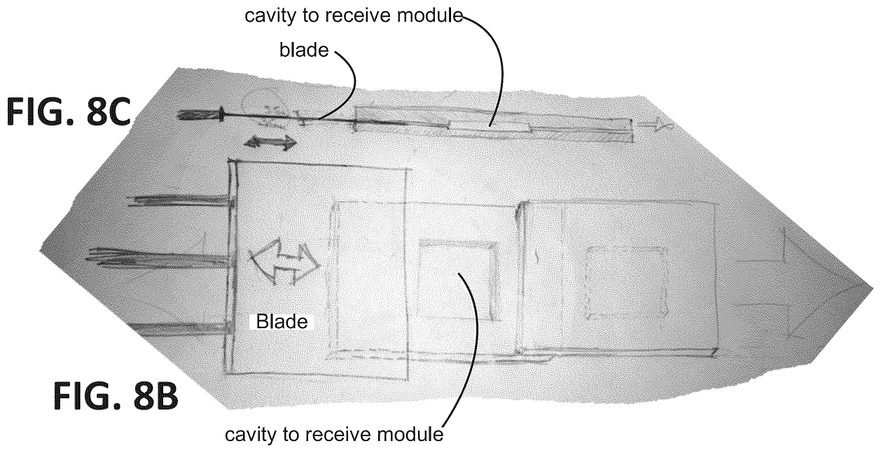

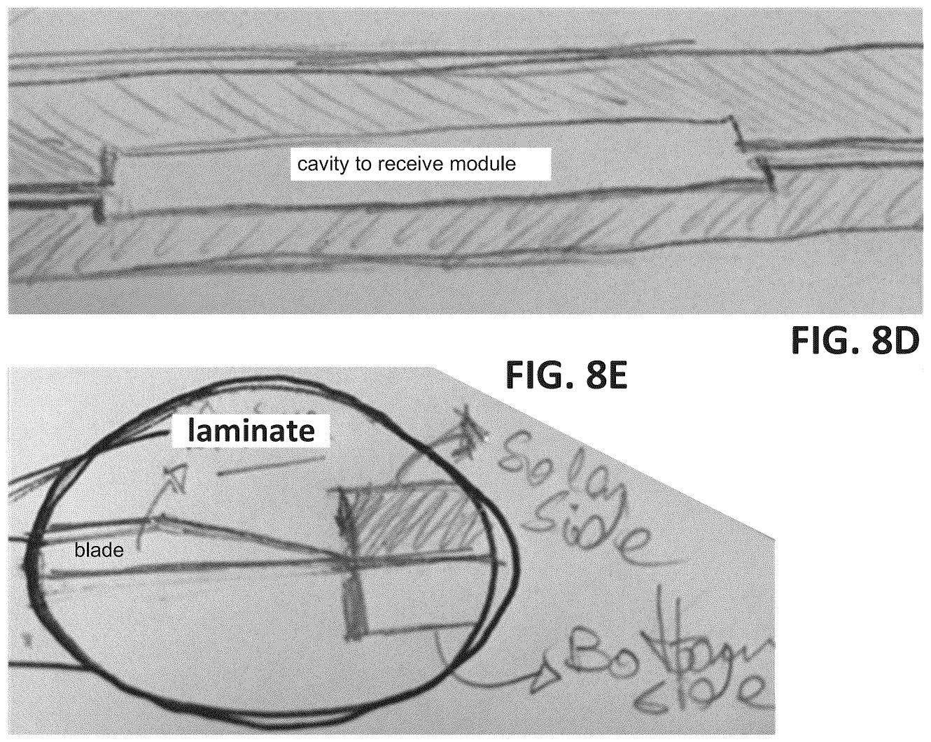

Testing was also performed utilizing a different method for applying shear forces for delamination, not relying upon the use of adhesive. Specifically, after junction box removal and deframing, a CdTe laminate was introduced into a cavity defined within a bipartite device. FIG. 8A shows a cross-section of the CdTe laminate.

FIG. 8B shows an overhead view of an embodiment of an apparatus for applying a shear force for delamination, with the cavity unoccupied and including a blade (which may or may not be used). FIG. 8C shows a cross-sectional view of the apparatus of FIG. 8B.

FIG. 8D shows an enlarged cross-sectional view of the cavity defined within the bipartite device. FIG. 8E shows an enlarged view of the blade tip encountering the thin film(s) located between the glass of the bottom side and the glass of top (solar) side of the laminate.

With the laminate previously heated, the test separated the two layers of glass of the CdTe laminate, without even requiring the use of a blade. The bipartite shearing device has a cavity to receive the module and serve as a confinement enclosure for receiving the module fragment.

The cavity may be slightly thinner than the laminate thickness. In this manner, the individual parts of the bipartite device are displaced relative to one another, the bottom side constrains the bottom ply (bottom glass sheet and any internal layers remaining attached thereto) while the top side pushes the top ply (top glass sheet and any internal layers remaining attached thereto).

After positioning the laminate inside the bipartite device, a shear force was applied between the pieces, separating the two different glass layers from each other.

During the test, a blade was not used. In some embodiments, a thin sheet may be used as a blade to facilitate the separation initially. The thin sheet (blade) may be heated or unheated.

This particular embodiment can separate the glass layers (bottom and top/solar), even with the glass cracked or broken.

Also, more than one setup may be implemented to the same tool. Various setups could aim to delaminate different module types.

Based upon identification of a module type (e.g., according to weight and/or size or other information) a system may raise/lower selected members to match the corresponding module type.

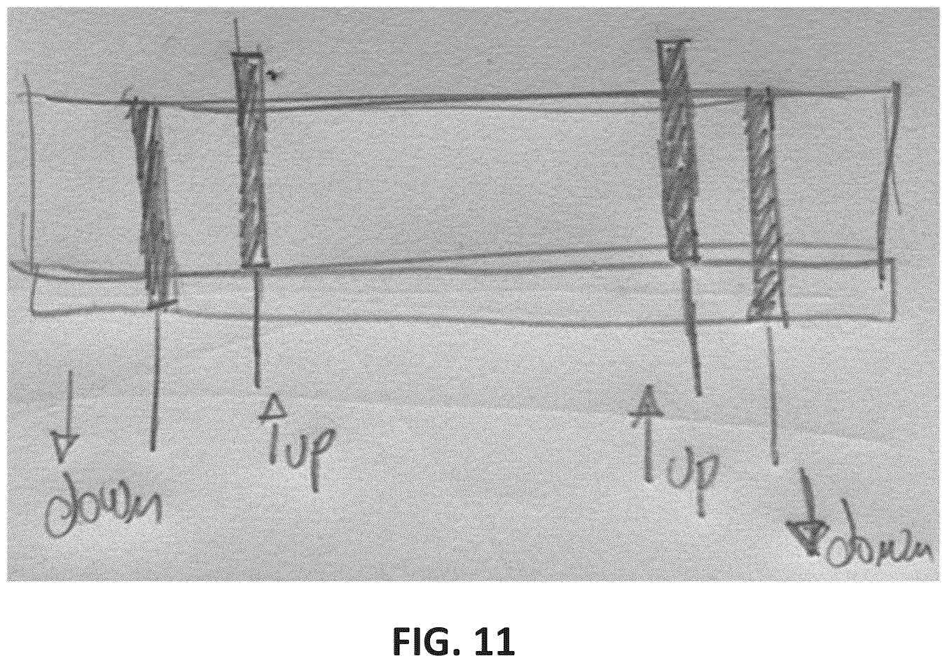

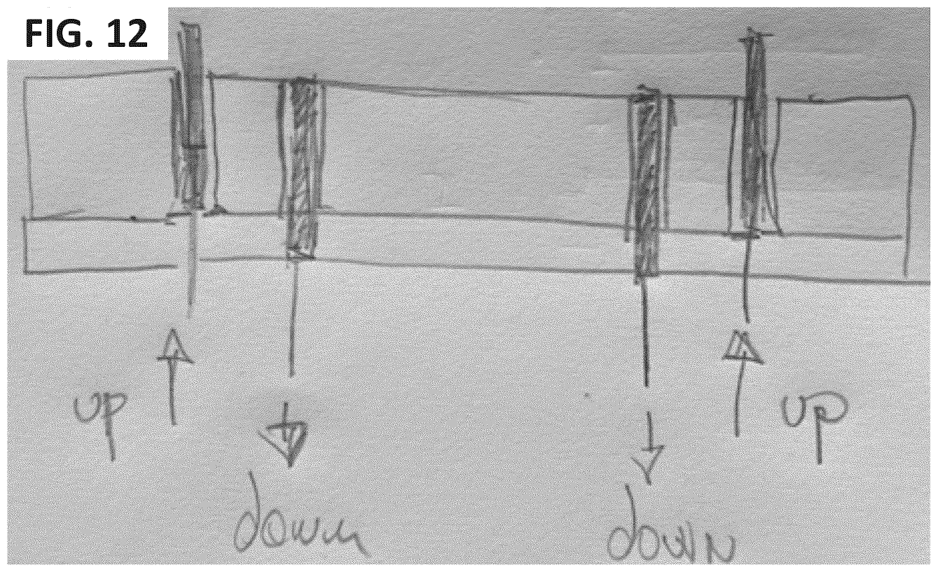

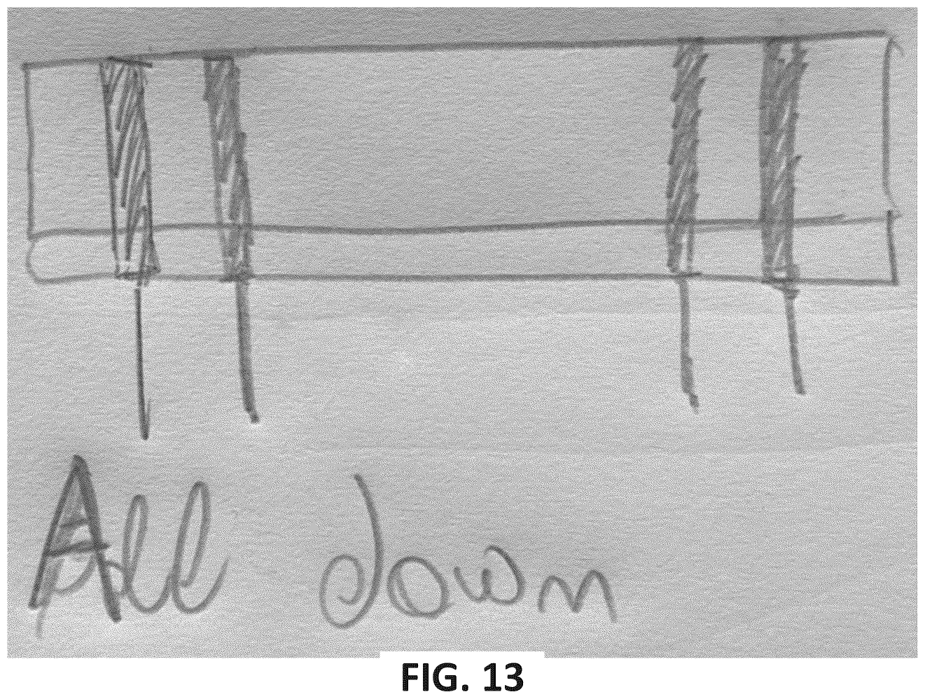

FIGS. 11 and 12 provide an idea of how these up and down movements of the members could work to accommodate different module types for delamination. FIG. 13 shows how it would look like when all of the members are actuated in the same direction.

By allowing a same delamination device to accommodate different module types, this may potentially offer lower costs of segregation between next steps of recycling when having a continuous process.

The cavity-shear concept was proven successful when tested in a small-scale prototype, made from wood blocs. This indicates that not much resistance was encountered. The CdTe sample was enough heated using either an IR bulb as a heat gun for less than a minute, to weaken the middle layers to a state that it was feasible to separate the glass pieces.

Also, since the sample has no conventional shape, it is probably a good indication, that it could work on cracked panels when in full-scale size. (During the tests none of the sample had the exact size of the cavity, but the two glass pieces managed to be successfully separated).

As a result of delamination, one of the resulting separated glass sheets may have most of the thin film layers (semiconductor, conductor, and/or insulator) remaining attached thereto. This is due to the order in which the layers are applied to the bottom sheet during fabrication (e.g., thin film deposited directly onto the bottom glass, and hence being bonded more strongly thereto).

Because of the order in which the layers are applied to the substrate glass face (thin film is deposited directly onto the glass), only one (the bottom) glass sheet has the bulk of the semiconductor (metals and semimetals) attached to it, while the other glass sheet comes to seal the structure at the end of the process and make up the sandwich.

Thus, the separation of the thin film panel into two glass sheets (or two glass cullet groups, if glass is broken) often leaves one glass sheet (or group) relatively residue free—or with primarily encapsulant (polymer) contamination. Such mainly encapsulant contamination is not considered an obstacle to making new optical glass.

The other sheet (or cutlet group) including the internal layers may be further processed following delamination. Such post-delamination processing may accomplish material separation, recovery, and/or purification.

Post-delamination purification of the second sheet (or cullet group) can be undertaken in different ways. One way is by the use of mechanical force to scrape the glass surface, and thereby remove the deposited layers mechanically.

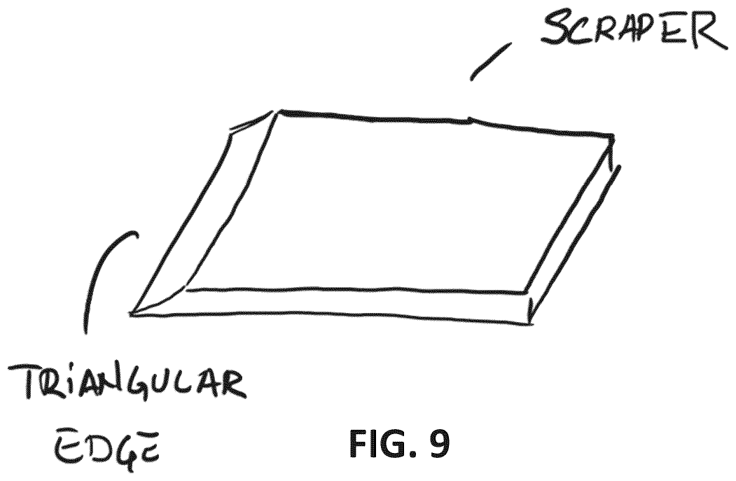

FIG. 9 shows a simplified view of such a scraper according to an embodiment. The layers may not exhibit high mechanical strength or offer much resistance to scraping movement.

Another approach is to place the delaminated sheet (or cullet group) in a vibratory tumbling equipment (or similar). There, materials can be polished/abraded by a media, with a minimum of breaking/crushing/milling.

The resulting effect is that the layers on the surface of the glass are removed/separated from the glass particles. These layers can then be recovered using sieves (e.g., due to the glass particles being larger than the semiconductor particles).

In some embodiments, recovery may also be accomplished via density separation. This is due to the metals in question (Se, Zn, Te, Cd) having a greater density than glass.

Another way to purify the second glass sheet (or group) is to chemically etch/leach the metals that make up the internal layers. This can be done by the use of organic and/or inorganic solutions. Examples include the use of nitric acid and piranha solution (a combination of sulfuric acid and hydrogen peroxide).

Once leached, the glass sheet (or cullet group) and the polymers will remain as solids. Other components will be present in the solution.

Thus, a filtering process can separate the materials and recover the glass and polymers. The solubilized materials can then be recovered using one or more techniques, e.g.:
solvent extraction,
ion exchange,
electrowinning,
precipitation.

The chemical purification method may work whether the two glass sheets (or cullet groups) were sorted and separated beforehand, or simply milled/crushed/shred all together. Possible benefits of separating the glass beforehand may include one or more of the following i)-vi) below.
i) More material is recovered, because 50% of the glass (i.e., one full glass sheet or cullet group) is recovered. Additional processing (leaching and/or filtering) that could reduce recovery yield, is not required.
ii) The equipment used for delamination may have a higher throughput. This is because only about half the mass is entering the downstream processes.
iii) There may be less need for chemicals. This is because less mass is entering the leaching process and the chances of the solution reacting with the mass is higher (e.g., because the semiconductor surface has been exposed).
iv) There may be a higher probability of leaching most of the semiconductor layer. This allows an increase in glass recovery of the second sheet (or second cullet group), and also an increase in semiconductor and metals recovery.
v) A smaller volume of wastewater may be produced-due to the same reasons of iii) and iv).
vi) Smaller equipment may be used for processing downstream of delamination, as glass represents a very large percentage of the volume of a panel laminate. By removing 50% of the glass prior, the mechanical tools (for scrapping or abrasion), the reactors (for leaching), and subsequent filters can occupy a smaller footprint in an industrial facility.

Recycling processes may seek to recover the materials contained in a thin film module at a high purity. Delamination that fails to expose internal layers of a used thin film module could possibly result in one or more of the following consequences.
A) Only a fraction of the internal layers would be recovered after the subsequent post-delamination processing.
B) portions of the materials (or components) of the used module that still contain the internal layers attached to them, are less pure than portions having the internal layer exposed. Example of such materials are the glass and encapsulant, which are often in direct contact with the internal layer.

It is emphasized that the approaches described above may be utilized alone, or in various combinations.

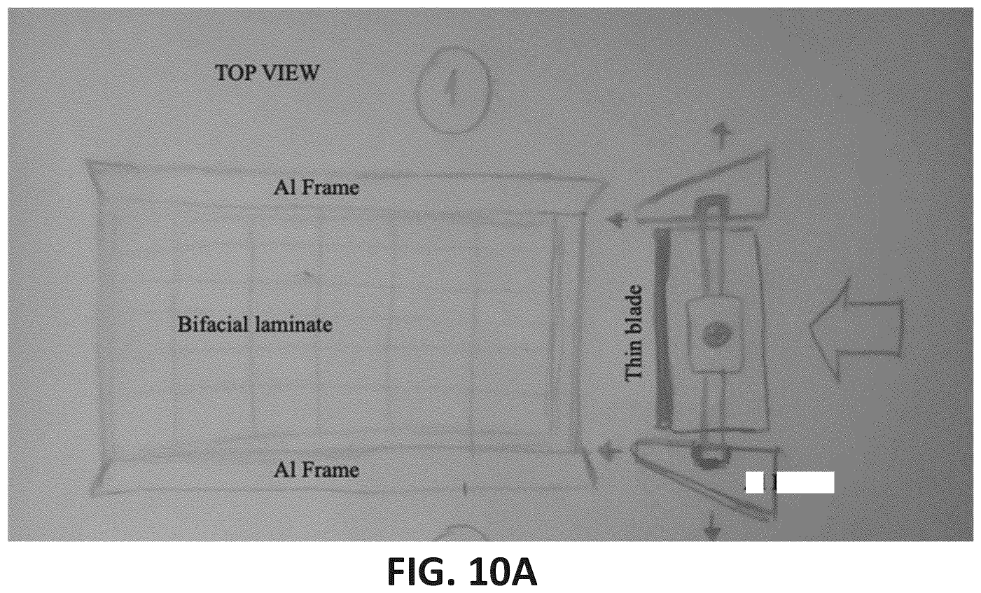

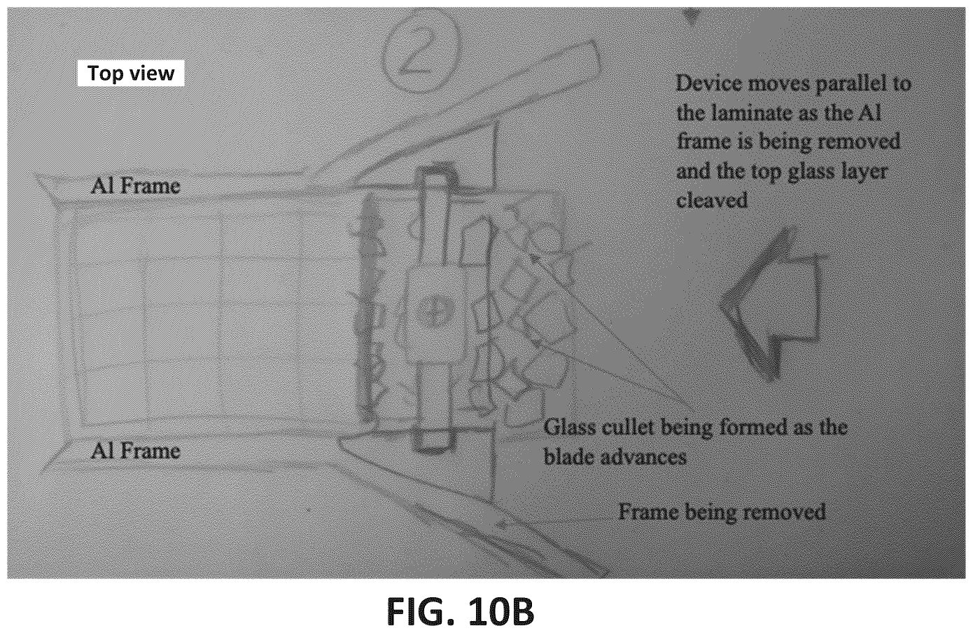

For example, FIG. 10A displays an embodiment of an apparatus for use in delamination, where a frame could be removed as glass layers are separated. FIG. 10B shows as the assembly is moved to the left, a thin blade cleaves the laminate. Two forming matrices bend the frame gradually until its total release.
Clause 1A. A method comprising:
providing a used solar module comprising,
encapsulant, and
a top transparent sheet overlying a photovoltaic layer including an element, formed upon a bottom sheet; and
applying energy to separate the bottom sheet bearing the photovoltaic layer.
Clause 2A. A method as in Clause 1A wherein applying the energy separates the top transparent sheet bearing encapsulant.
Clause 3A. A method as in any of Clauses 1A or 2A wherein the top transparent sheet comprises glass.
Clause 4A. A method as in any of Clauses 1A, 2A, or 3A wherein the bottom sheet comprises glass.
Clause 5A. A method as in any of Clauses 1A, 2A, 3A, or 4A wherein the used solar module is bifacial.
Clause 6A. A method as in any of Clauses 1A, 2A, 3A, 4A, or 5A wherein the photovoltaic layer comprises Cadmium.
Clause 7A. A method as in any of Clauses 1A, 2A, 3A, 4A, 5A, or 6A wherein the photovoltaic layer comprises Tellurium.
Clause 8A. A method as in any of Clauses 1A, 2A, 3A, 4A, 5A, 6A, or 7A wherein the photovoltaic layer comprises Cadmium Telluride (CdTe).
Clause 9A. A method as in any of Clauses 1A, 2A, 3A, 4A, 5A, 6A, 7A, or 8A wherein the photovoltaic layer comprises silicon.
Clause 10A. A method as in any of Clauses 1A, 2A, 3A, 4A, 5A, 6A, 7A, 8A, or 9A wherein the photovoltaic layer comprises a-si.
Clause 11A. A method as in any of Clauses 1A, 2A, 3A, 4A, 5A, 6A, 7A, 8A, 9A, or 10A wherein the photovoltaic layer comprises perovskite.
Clause 12A. A method as in any of Clauses 1A, 2A, 3A, 4A, 5A, 6A, 7A, 8A, 9A, 10A, or 11A wherein the used solar module comprises Tellurium.
Clause 13A. A method as in any of Clauses 1A, 2A, 3A, 4A, 5A, 6A, 7A, 8A, 9A, 10A, 11A, or 12A wherein the used solar module comprises Selenium.
Clause 14A. A method as in any of Clauses 1A, 2A, 3A, 4A, 5A, 6A, 7A, 8A, 9A, 10A, 11A, 12A, or 13A wherein the used solar module comprises Zinc.
Clause 15A. A method as in any of Clauses 1A, 2A, 3A, 4A, 5A, 6A, 7A, 8A, 9A, 10A, 11A, 12A, 13A, or 14A wherein the energy is mechanical energy.
Clause 16A. A method as in any of Clauses 1A, 2A, 3A, 4A, 5A, 6A, 7A, 8A, 9A, 10A, 11A, 12A, 13A, 14A, or 15A wherein the energy comprises a shear force.
Clause 17A. A method as in Clause 16A wherein the shear force is applied at an angle.
Clause 18A. A method as in any of Clauses 1A, 2A, 3A, 4A, 5A, 6A, 7A, 8A, 9A, 10A, 11A, 12A, 13A, 14A, 15A, 16A, or 17A wherein the energy comprises thermal energy.
Clause 19A. A method as in any of Clauses 1A, 2A, 3A, 4A, 5A, 6A, 7A, 8A, 9A, 10A, 11A, 12A, 13A, 14A, 15A, 16A, 17A, or 18A further comprising processing the separated bottom sheet to purify the element.
Clause 20A. A method as in any of Clauses 1A, 2A, 3A, 4A, 5A, 6A, 7A, 8A, 9A, 10A, 11A, 12A, 13A, 14A, 15A, 16A, 17A, 18A, or 19A further comprising grouping the separated bottom sheet with a sorted bottom sheet of another used solar module.

Thin film modules can be made with internal layers of materials other than silicon acting as semiconductors. One form of thin film module utilizes Cadmium Telluride (CdTe) as a photovoltaic material. Other examples of thin film panels include those with Amorphous silicon (a-Si), Multijunction cells (a-Si-μc Si), Copper indium gallium diselenide (CIGS), and copper indium diselenide (CIS).

CdTe modules may have additional materials in the thin film structure in addition to CdTe. Examples of such other materials can include but are not limited to Selenium, Zinc, ZnTe, and others. Thin film solar modules (such as CdTe) often include photovoltaic material sandwiched by two glass sheets.

A semiconductor comprising CdTe is located between the glass sheets of the solar side and the bottom side. Other internal layers may comprise one or more of:
encapsulant,
rear conductors (generally metals such as copper),
insulators,
transparent conducting layer (or transparent conducting oxide),
buffer layer (generally located between the top/solar transparent sheet and the transparent conducting layer).

Internal layers may be isolated from the exterior of the module, which can offer harsh temperature and moisture (e.g., snow, rain, humidity) conditions. The outer structure of a module can feature a metal (e.g., aluminum or steel) frame for support. Other module types may lack a frame.

One or multiple junction boxes are placed on the outer part of the panel (e.g., on the bottom glass), in order to allow leads to conduct electric current.

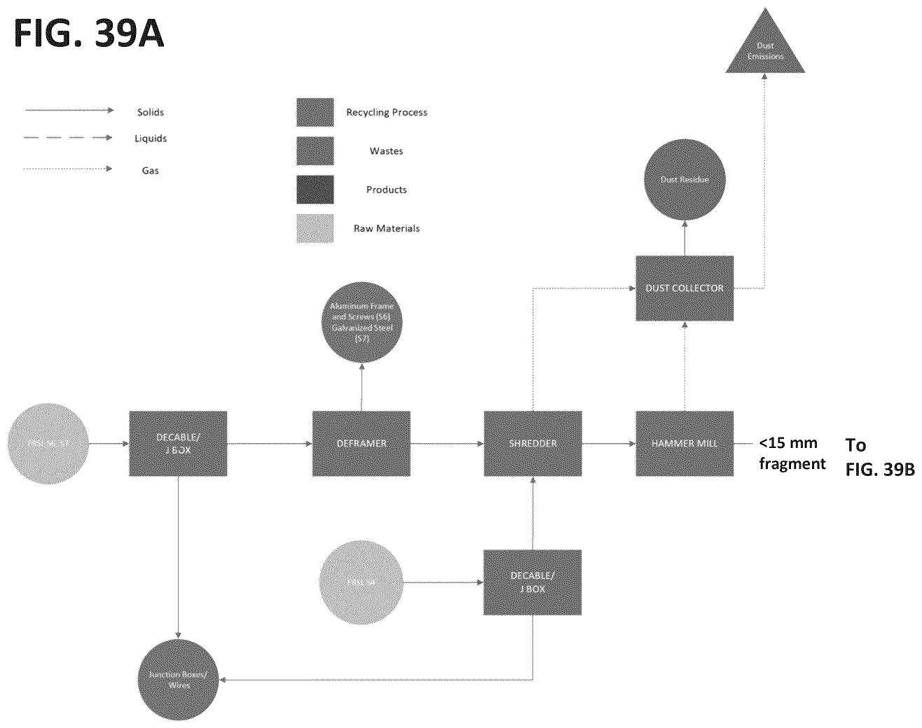

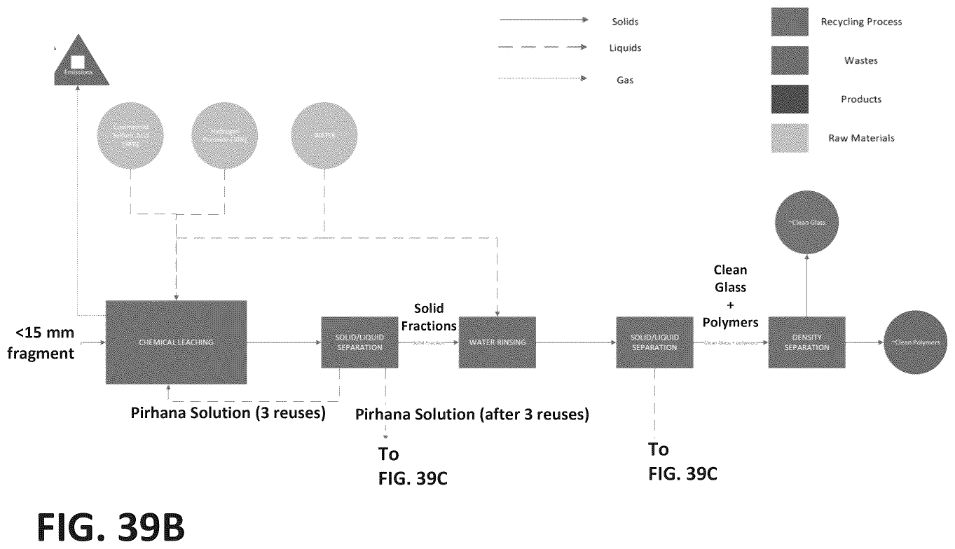

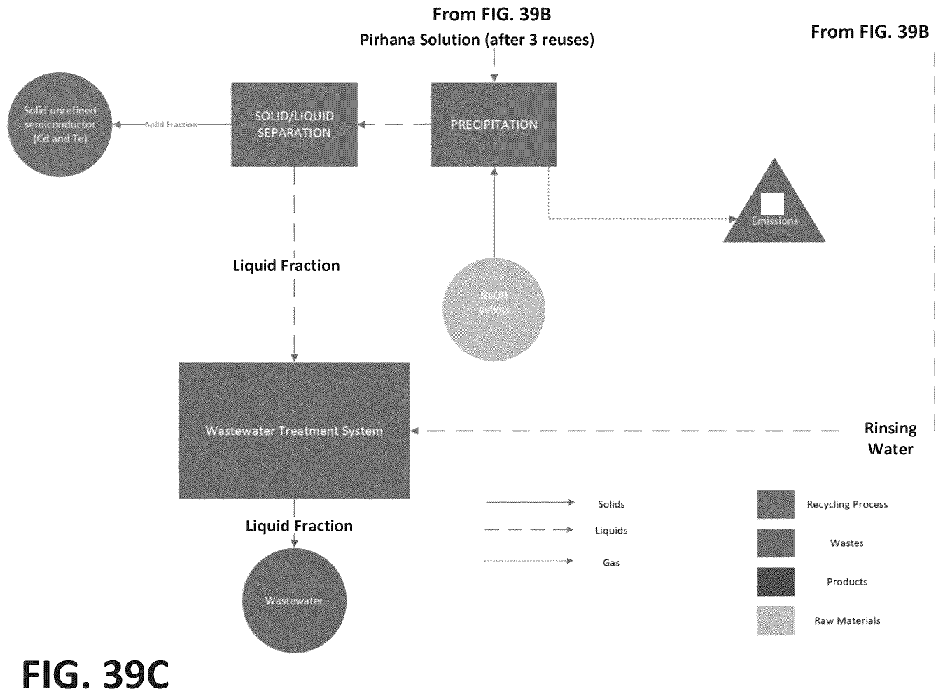

Embodiments relate to processing of used thin film solar modules that allow for disposal and/or recycling. FIGS. 39A-39C show a simplified flow diagram illustrating a process flow involving both mechanical and chemical processing.

Various examples are now offered relating to the processing of used CdTe solar modules.

### EXAMPLES

Recyclable CdTe solar panels can be mechanically and/or chemically processed. For the mechanical processes, the modules may be provided to equipment to remove both aluminum frames and junction boxes. The remaining materials are milled in a defined granulometry, and the outputs are introduced to the chemical reactor.

Chemical processing can involve leaching of the milled CdTe material with a specific range of particle size distribution. Leaching may use an acid mixture (e.g., based on sulfuric acid and hydrogen peroxide). In a particular embodiment, the acid solution is a 3:1 mixture of sulfuric acid 1.5M with hydrogen peroxide 30%.

The solid fraction is rinsed with water and dried. The leaching and rinsing solutions are recycled in the process multiple (e.g. at least three, and here six) times. Then, both are subjected to precipitation steps. Such precipitation can include addition of flocculant and/or coagulant and a NaOH neutralizing solution.

Table 1 below shows Cd and Te recovered by each recycle of the process.

| | | Total Cd | Total Te |
|---|---|---|---|
| | | Recovery | Recovery |
| Leaching Test | Interpretation | (%) | (%) |
| Piranha Solution 2 | | 97.05 | 72.10 |
| Water Rinsing 2 | | 2.95 | 1.01 |
| | Leaching effectiveness | 100 | 73.11 |
| Water Rinsing Effec. 2 | | 0.00 | 5.56 |
| Aqua Regia 2 | | 0.00 | 21.33 |
| | Remaining | 0 | 26.89 |
| | semiconductors in solids | | |
| | (glass and polymer) | | |
| Piranha Solution 4 | | 93.53 | 71.01 |
| Water Rinsing 4 | | 5.01 | 3.00 |
| | Leaching effectiveness | 98.54 | 74.01 |
| Water Rinsing Effec. 4 | | 1.46 | 5.23 |
| Aqua Regia 4 | | 0.00 | 20.77 |
| | Remaining | 1.46 | 26.00 |
| | semiconductors in solids | | |
| | (glass and polymer) | | |
| Piranha Solution 6 | | 85.42 | 71.36 |
| Water Rinsing 6 | | 10.89 | 7.70 |
| | Leaching effectiveness | 96.31 | 79.06 |
| Water Rinsing Effec. 6 | | 3.68 | 4.22 |
| Aqua Regia 6 | | 0.00 | 14.33 |
| | Remaining metals in | 3.68 | 18.55 |
| | solids (glass and | | |
| | polymer) | | |

Table 2 below shows leaching solution before and after precipitation results.

| | Before Precipitation | After Precipitation | Precipitation |
|---|---|---|---|
| Element | (ppm) | (ppm) | Efficiency (%) |
| Cd | 1052.63 | 0.95 | 99.91 |
| Fe | 764.39 | 1.05 | 99.86 |
| Te | 1077.42 | 104.6 | 90.29 |

Further details regarding processing in specific examples, are now provided below. For chemical leaching, tests were performed to evaluate the concentration and time parameters.

The samples were hammer-knife milled, quartered, and weighed to: 50+/−2 g. The solid/liquid ratio (1:2) remained the same during the tests.

The Piranha solution is a mixture of sulfuric acid and hydrogen peroxide on a 3:1 proportion. This mixture of chemicals generates a strong oxidizing agent.

The piranha solution tests were performed varying the concentrations of sulfuric acid: 0.5/1/1.5/2/2.5/3 M. The amount of peroxide hydrogen was kept fixed and collected each 30 minutes for two hours.

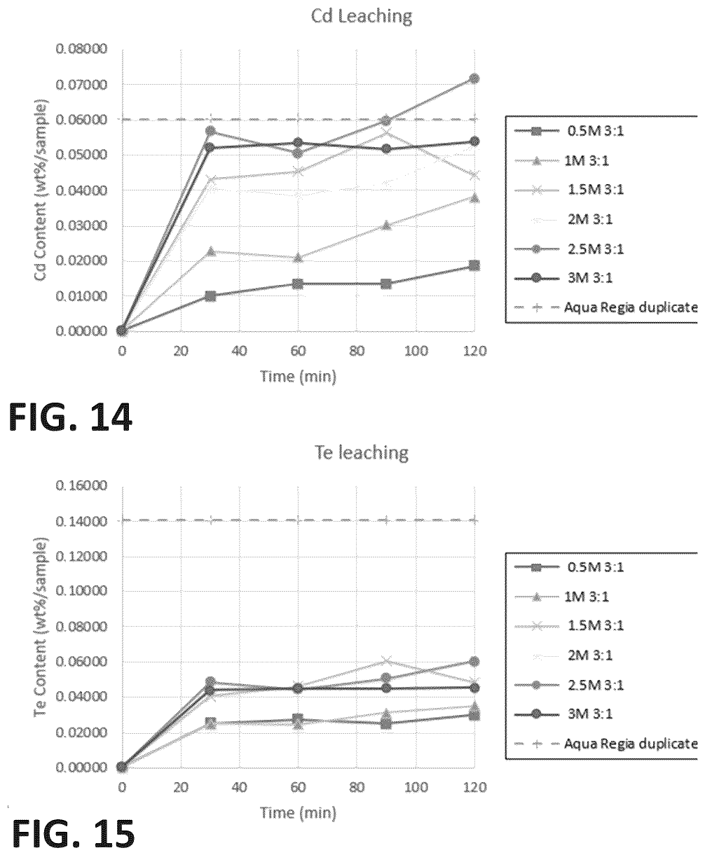

FIG. 14 plots Cd content over time, and FIG. 15 plots Te content over time, using Piranha solution under different sulfuric acid concentrations (hammer-knife-milled). In both cases, the content was determined by Inductively Coupled Plasma-Optical Emission Spectrometry (ICP-OES).

After these tests, a desirable leaching solution was defined as the piranha solution with a concentration of sulfuric acid as 1.5M.

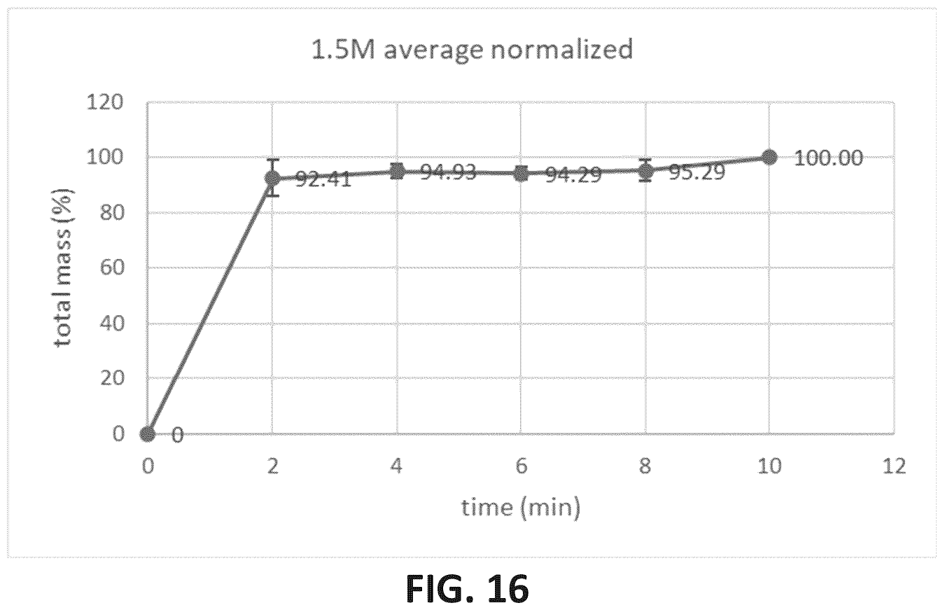

Regarding the time parameter for leaching, another series of experiments were conducted collecting samples every 2 min until a total of 12 min. To evaluate the leached metal over time, the results were normalized in respect to the maximum Cadmium extraction from the last experiment at 10 min. FIG. 16 shows ICP-OES results for Cadmium using Piranha solution under Piranha solution 1.5M over time.

For the next round of experiments, the leaching time was defined as 10 minutes. After wastewater and peroxide minimization, the leaching time was increased to 20 minutes.

The solid/liquid ratio was defined with empirical tests by the following. The leaching occurred in a flask containing the sample, the leaching solution, and a magnetic stirrer.

Using lower solid/liquid ratios (high solid concentration) turns the stirring process difficult to maintain constant. Thus, the solid/liquid ratio 1:2 was determined in a way that it remained constant for the adequate reproducibility of the process.

Preliminary process characterization took place as follows. A CdTe solar panel (First Solar, Series 6, FS-6460-A-P-I) was weighed and manually dismantled. The mass of each main component is shown in Table 3 below.

TABLE 3
Main components of the Series 6 CdTe solar module studied.

| Component | Mass (kg) | wt % (%) | MODEL |
|---|---|---|---|
| CDTE MODULE | 33.8 | 100 | FS-6460-A-P-I |
| ALUMINUM FRAME & | 3.8 | 11.2 | FS-6460-A-P-I |
| MIDDLE BAR | | | |
| FRAMELESS MODULE | 30 | 88.8 | FS-6460-A-P-I |
| JUNCTION BOX + WIRES | 0.11661 | 0.345 | FS-6460-A-P-I |
| SCREWS | 0.0172143 | 0.051 | FS-6460-A-P-I |

The mass characterization matches with the information presented in the series 6 EP. The Aluminum frame matches with the 6005A based on the literature (ASM Metals Handbook Volume 2 Book).

Regarding sieving, a CdTe solar panel (First Solar, FS6425A) was dismantled and broken into pieces. The pieces were then hammer-milled with a screen opening of 1.5 cm.

The milled materials were sampled, weighed, and sieved.
The sieving results are presented in Table 4 below.

| Sieve # | Opening (mm) | % Weight of Mass Fraction |
|---|---|---|
| 3/8 | 9.51 | 4.65 |
| 4 | 4.76 | 7.8 |
| 9 | 2.0 | 4.3 |
| 16 | 1.19 | 24.02 |
| 32 | .5 | 24.21 |
| 60 | .25 | 18.03 |
| Pan | — | 16.96 |

Chemical characterization was as follows. The chemical leaching (First Solar, Series 6, FS-6460-A-P-I) was performed using a piranha solution with a 1.5M sulfuric acid for ten minutes.

The solution was reused three times (total four). The volumetric losses after each leach were completed with a brand-new piranha solution.

After the chemical leaching, the leached samples were rinsed with ultrapure water under the same solid/liquid ratio (1:2). The rinsed samples were vacuum filtered with the aid of a filtration paper (14 μm).

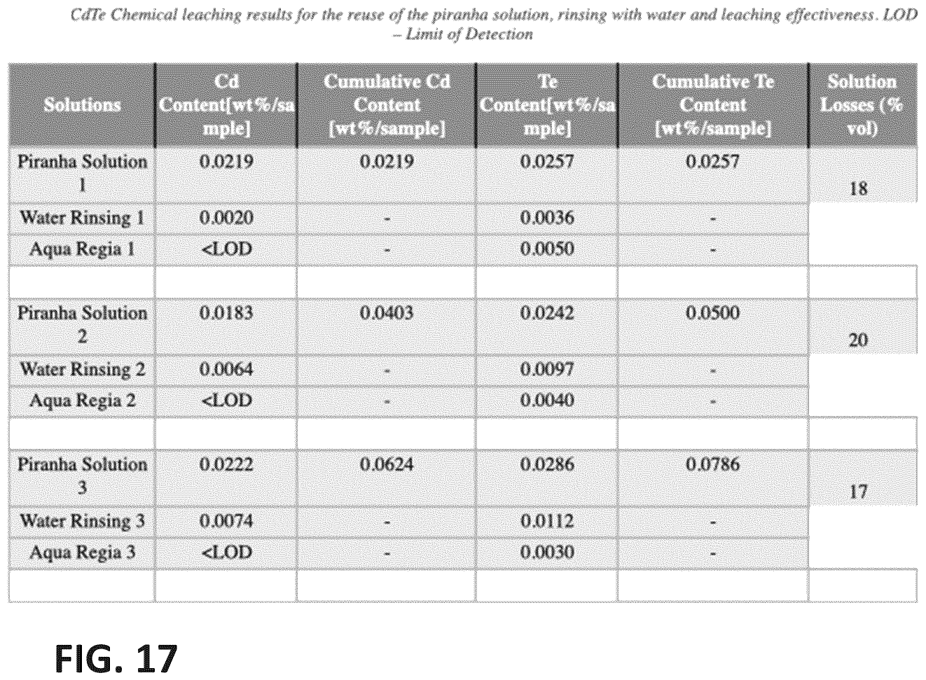

Then, to evaluate the leaching effectiveness, the samples were re-leached with aqua regia for two hours with a 1:6 solid/liquid ratio under heating (80° C.). FIG. 17 shows CdTe Chemical leaching results for the reuse of the piranha solution, rinsing with water and leaching effectiveness. LOD=Limit of Detection.

The results show that the chemical leaching using the piranha solution was effective for the samples considering the removal of cadmium. The effectiveness of the recovery of cadmium with the piranha solution was confirmed with the leaching of the same samples with the aqua regia.

The reuse of the piranha solution can remove the cadmium presented in four samples, but may not remove all the tellurium. The rinsing water may concentrate the Cadmium and Tellurium but this is related to the effectiveness of the solid/liquid separation system.

It may be desirable to minimize wastewater during processing. According to one particular sample approach, wastewater generation may not surpass the limit of 25,000 gallons per day.

For wastewater minimization, the following two approaches were studied:
reusing Piranha solution and its effectiveness.
evaluating reuse of the rinsing water and its effectiveness.

In one embodiment, a six-use piranha/rinsing solution was employed. The solid/liquid ratio was 1:1.5, and two more uses of the piranha solution were tested.

The reuse of the rinsing water was also tested six times. The rinsed solid was rinsed again to evaluate the effectiveness of the first rinsing process (the assumption is that any leftover semiconductor would show up in the second rinsing water chemical assessment). The results are shown above in Table 1.

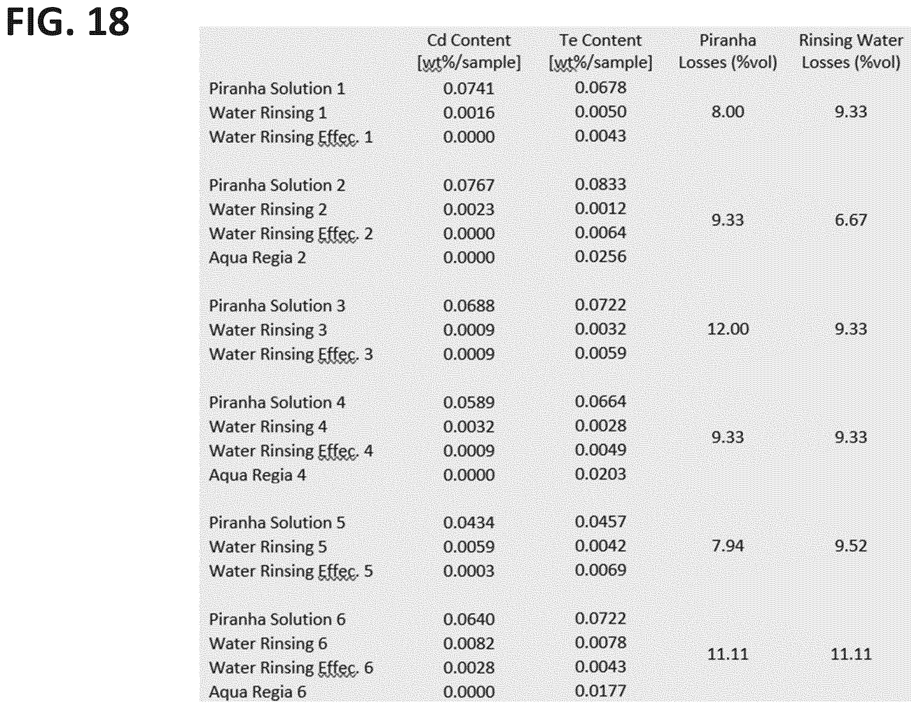

FIG. 18 shows Cadmium and Tellurium content evaluated in each step of the leaching process and effectiveness. This table shows that the water rinsing reuse is possible, but it still contaminates the solid fraction with both semiconductors. One possible factor would be the solid/liquid separation processes (both piranha and rinsing water) such that more semiconductors are recovered, and less liquid (and subsequently semiconductors) contaminates the solids.

Wastewater characterization occurred as follows. After the sixth use of the piranha solution, a sample was collected and precipitated with the addition of a NaOH 50 wt % solution under stirring until pH 8.

The liquid fraction (a possible wastewater generated at the process) was analyzed. The Metals (As, Al, Cd, Cr, Cu, Pb, Mn, Hg, Mo, Ni, Se, Ag, Zn were analyzed via ICP-OES; TSS (Total Suspended Solids).

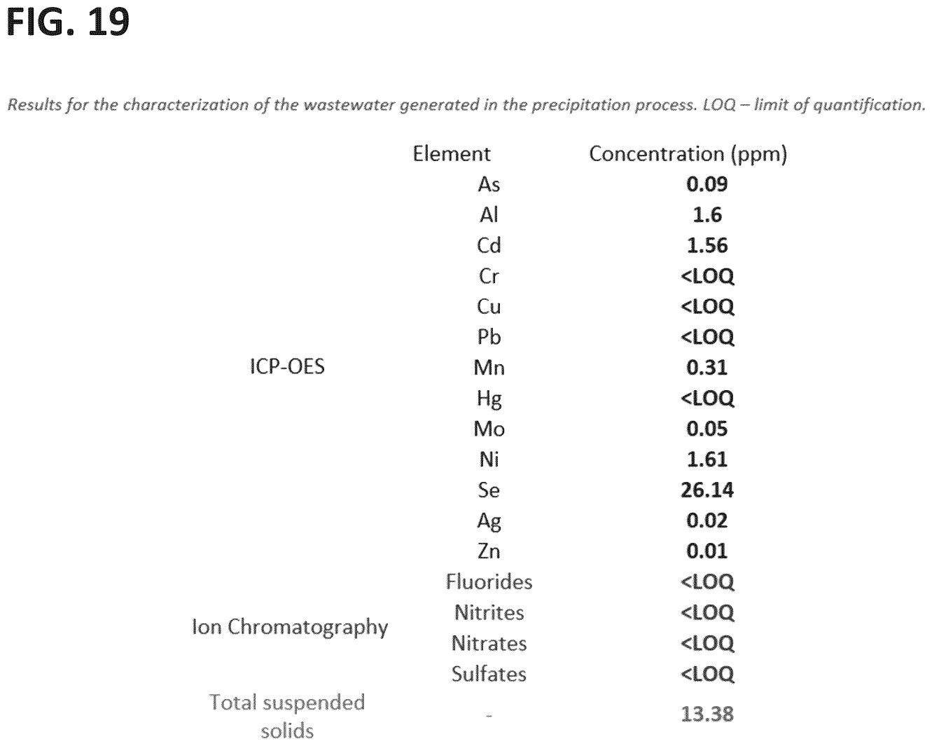

The presence of fluorides, Nitrites/Nitrates and Sulfates was analyzed via ion chromatography. FIG. 19 shows a table of the results. The results show a high concentration of Se relative to other metals evaluated.

The wastewater generated may be subject to the waste characterization criteria. As set out in 40 CFR 261 Subpart C, the Resource Conservation and Recovery Act (RCRA) specifically sets forth the characteristic criteria for corrosivity and toxicity.

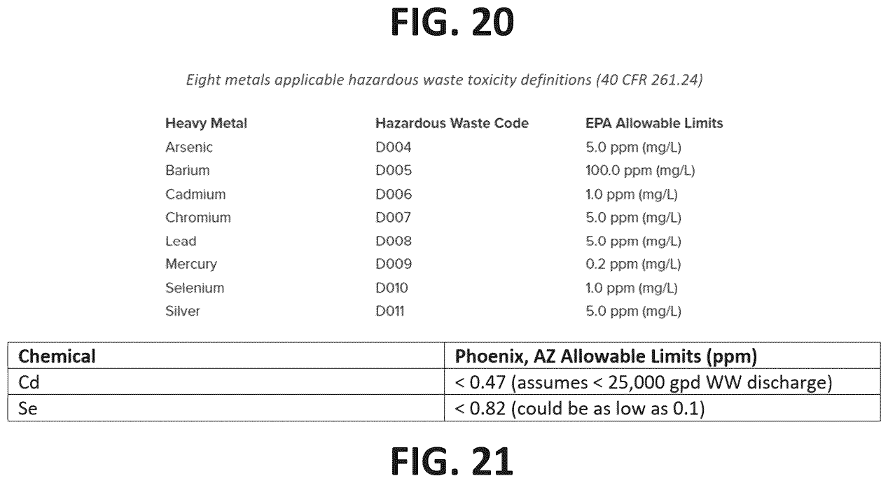

The applicable hazardous waste corrosivity definition is limited to wastewater streams with pH values above 12.5 and below 2. The applicable hazardous waste toxicity definitions (40 CFR 261.24) are limited to eight metals as shown in table of FIG. 20 below.

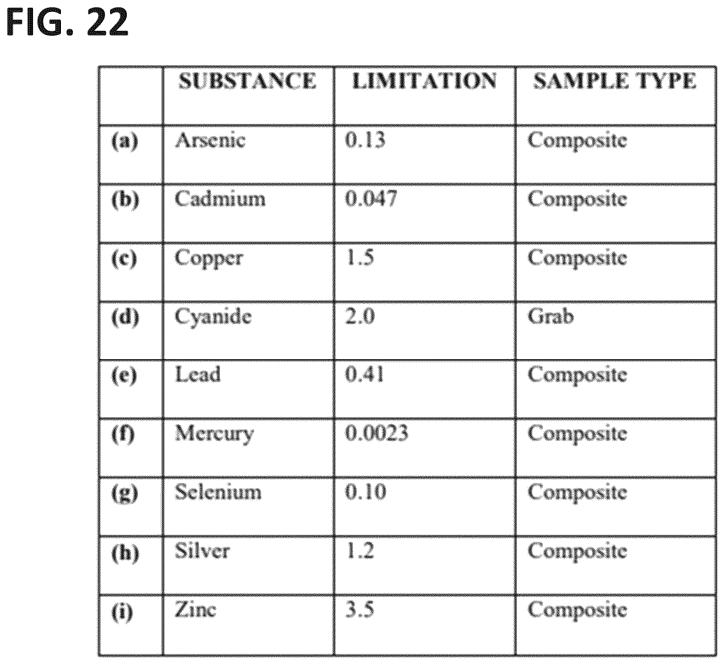

Moreover, local jurisdictions may set forth other rules. For example, the City of Phoenix has the following more stringent requirements for wastewater discharge compliance concentrations. This is shown in FIG. 21. FIG. 22 presents a list of discharge limits (in mg/L) for metal species.

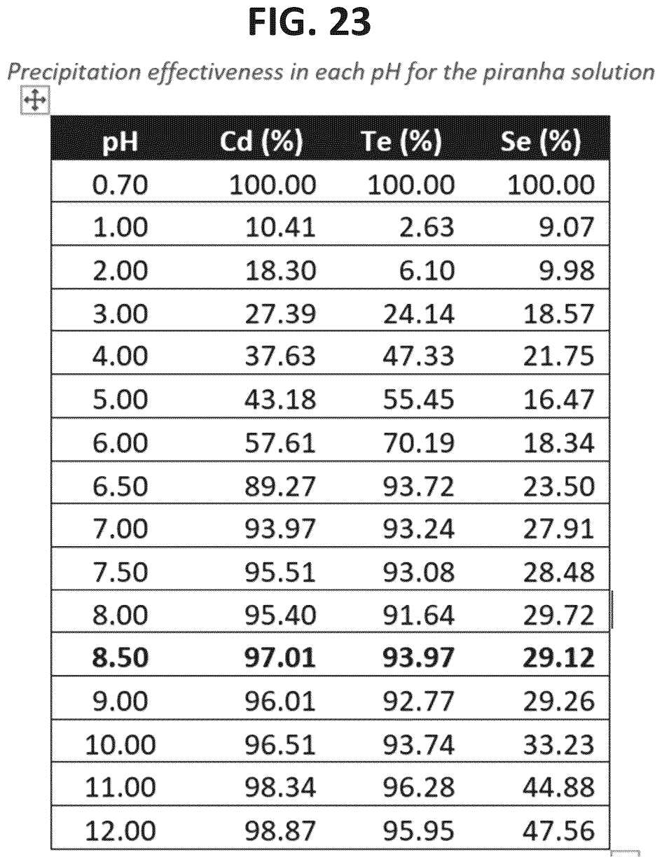

Precipitation trials were performed as follows. Precipitation tests were performed with NaOH to define the most suitable pH for the maximization of the precipitation of cadmium, tellurium, and selenium. Samples were collected in each pH presented in the table of FIG. 23, and the solution was analyzed and compared to the initial one.

The results show that it is possible to precipitate efficiently both cadmium and tellurium from the piranha solution at pH 8.5. So, a suitable precipitation was defined at pH 8.5.

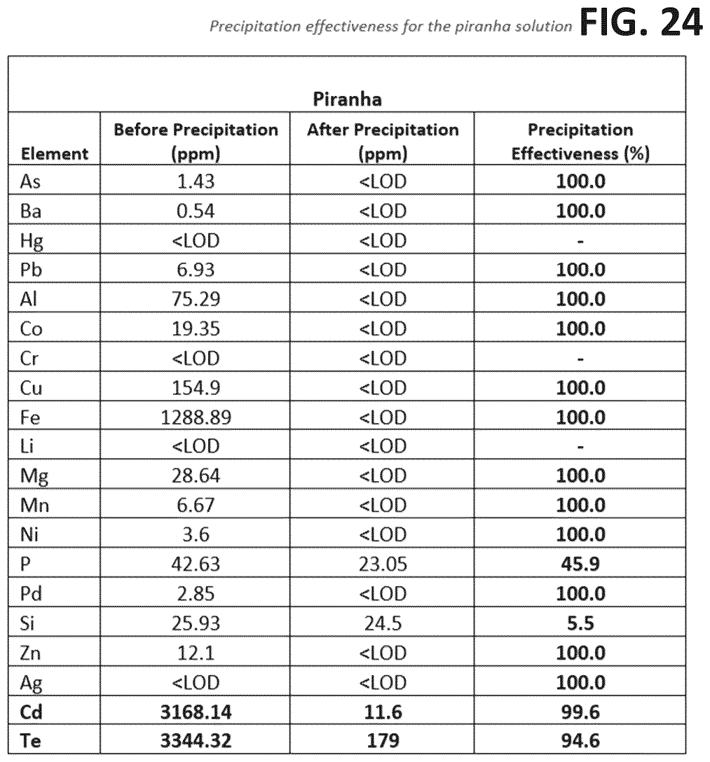

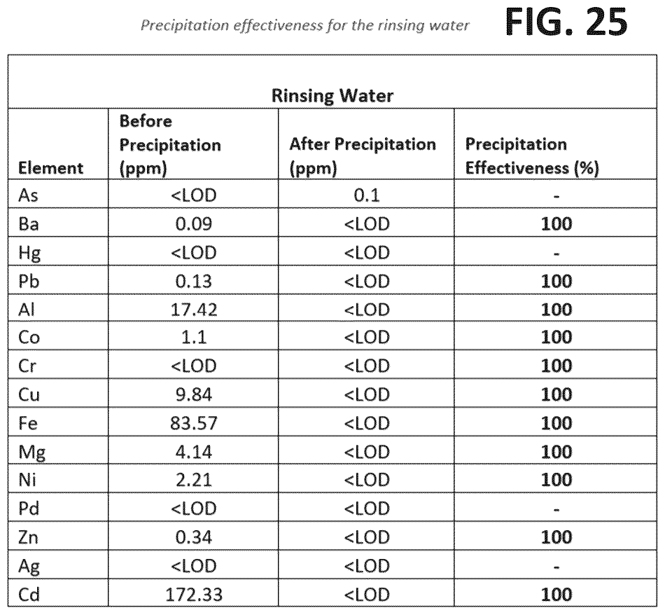

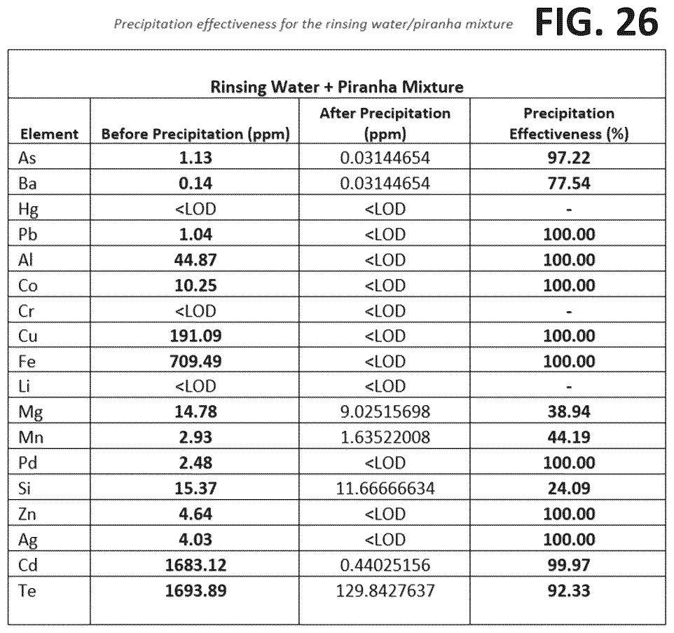

After the pH definition, three new rounds of precipitation were performed. The precipitation of the piranha (FIG. 24) and rinsing water (FIG. 25) was performed separately and mixed (FIG. 26). The results and how much NaOH 50 wt % was used are presented.

For the precipitation of 10 mL of the rinsing water, it was spent 0.1 mL of NaOH 50 wt %. For the precipitation of 10 mL of the piranha solution, it was spent 1.28 mL of NaOH 50 wt %. For the precipitation of 159 mL of the mixed piranha/rinsing (same proportion), it was spent 10.7 ml of NaOH 50 wt %.

Elemental characterization of the precipitate was performed as follows. The precipitate formed in the leaching of the sample from FIG. 26 (piranha+rinsing solution mixture) was analyzed via X-ray Fluorescence-Energy Dispersive Spectroscopy (XRF-EDS).

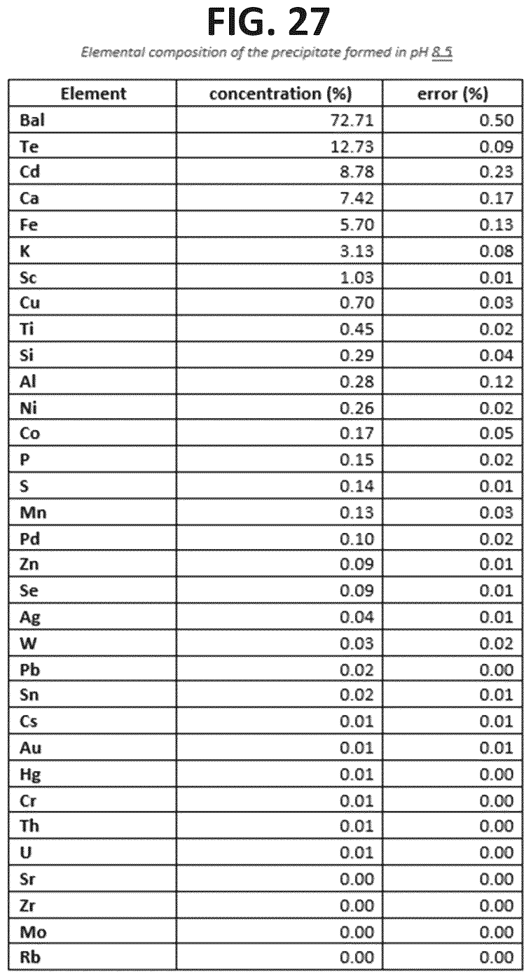

Based on the precipitate formed in this experiment, it is possible to conclude that it is generated 4.76 grams of precipitate per liter of the piranha+rinsing water mix. The duplicate results are presented in the table of FIG. 27.

It may be desirable to reduce an amount of peroxide utilized in chemical processing of used solar modules for recycling. Thus, a series of experiments were performed to reduce the quantity of peroxide in the piranha solution.

The peroxide was reduced by 50%-from 3:1 to 3:0.5 in the piranha solution sulfuric acid/hydrogen peroxide ratio. Again, a six-use piranha solution sequence was employed.

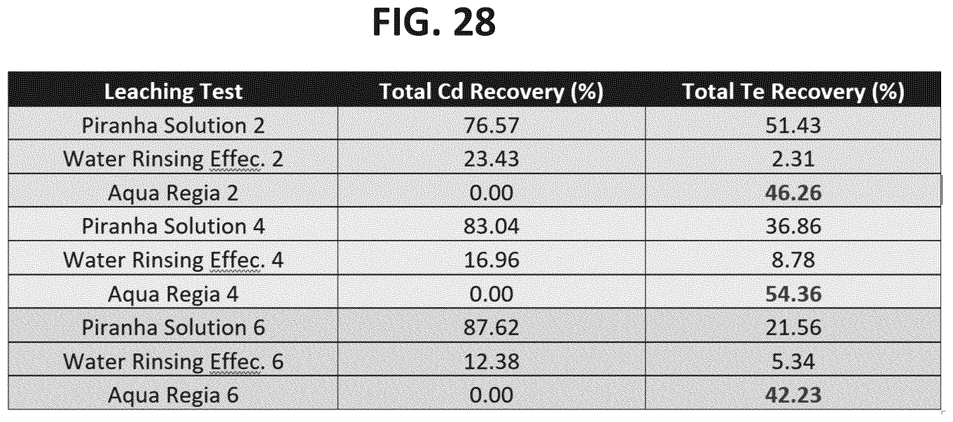

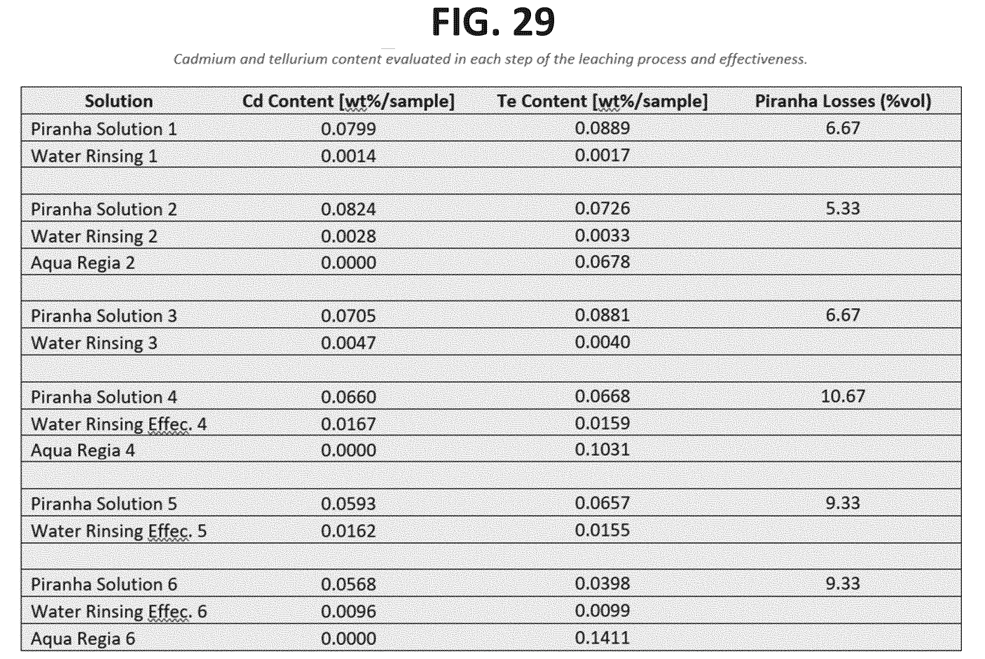

FIG. 28 shows total cadmium and tellurium recovered by each step of the process. FIG. 29 shows Cadmium and tellurium content evaluated in each step of the leaching process and effectiveness.

This experimental sequence indicated that the most part of the tellurium was removed by the aqua regia. Thus, the piranha with reduced peroxide content may not be as effective on removing the tellurium from the sample.

Shower experiments were performed to simulate leaching conditions that may be encountered in a processing plant. Shards of the solar module were created by hand to keep the particle size relatively large compared with what would be made by a lab hammer mill.

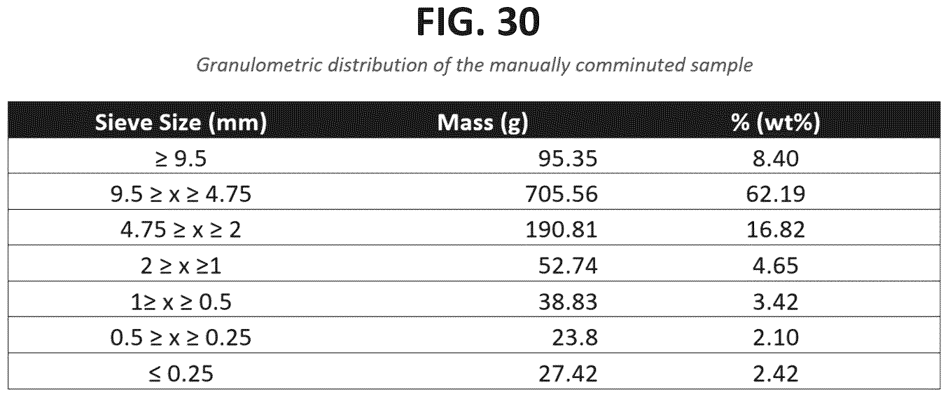

A majority of particles was >1.25 mm so that solid/liquid separation is easier (small particles would fall through the separation mesh). Then, the sample was comminuted with the aid of tools (hammers, cutters, etc) and sieved. FIG. 30 shows granulometric distribution of the manually comminuted sample.

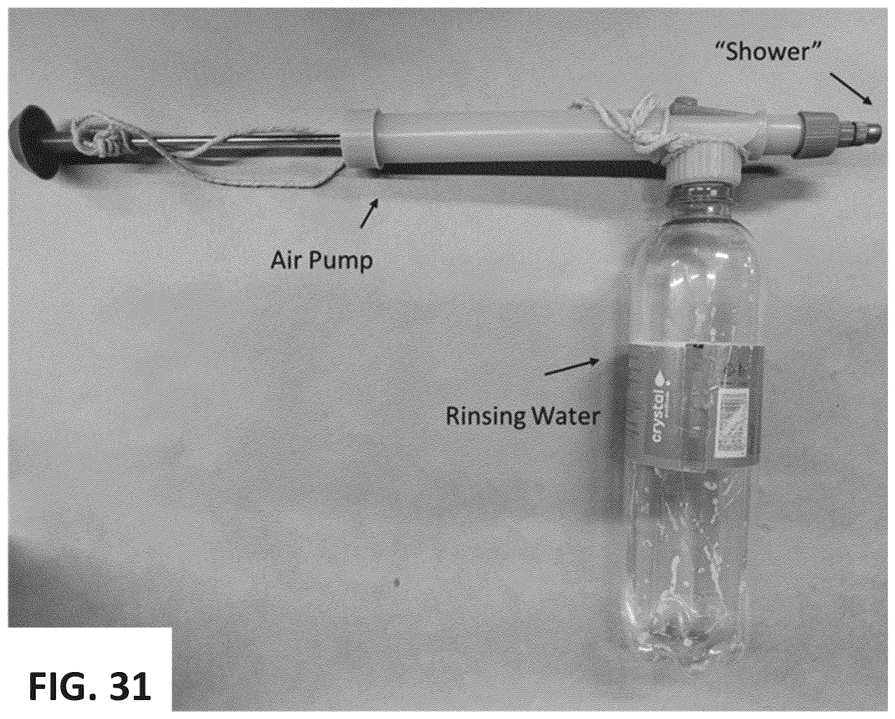

Also, to evaluate the leaching/rinsing effectiveness under such conditions, a showering device as shown in FIG. 31 was created in order to simulate rinsing equipment.

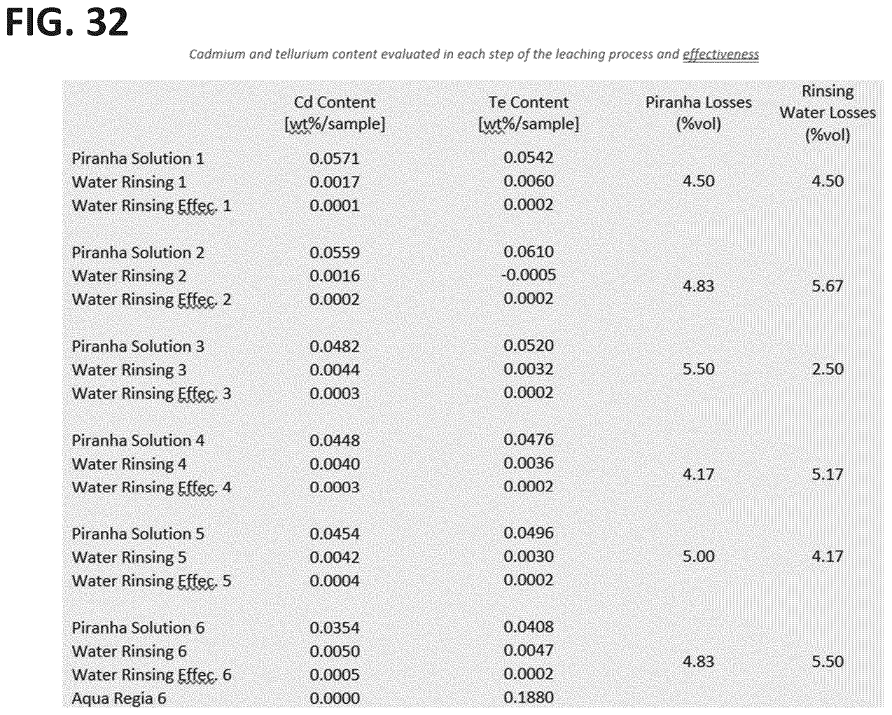

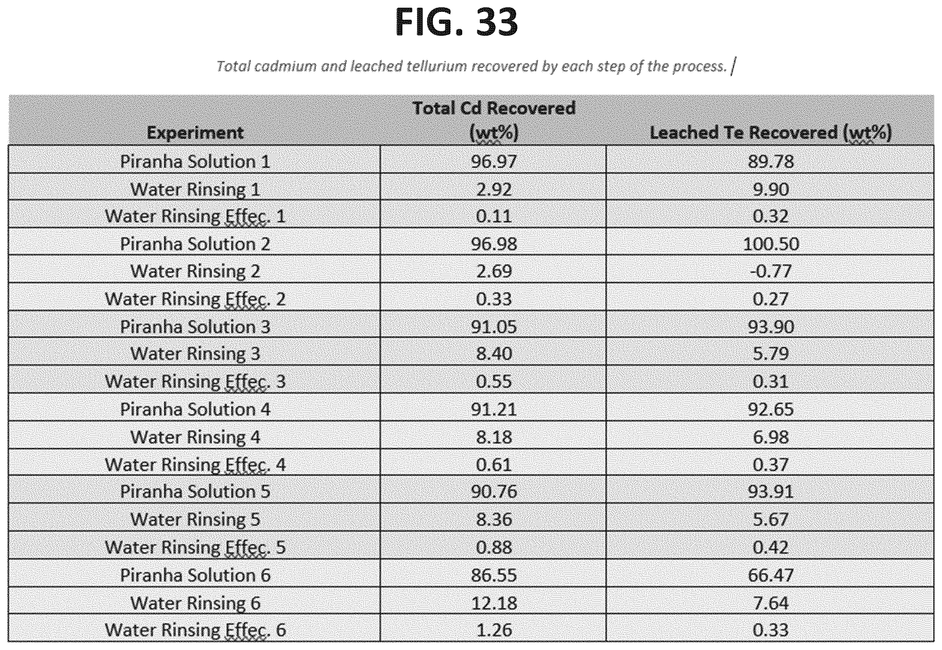

For this experiment, the granulometry x>1 mm was leached following the six use Piranha rinsing conditions with full strength peroxide. FIG. 32 shows Cadmium and tellurium content evaluated in each step of the leaching process and effectiveness. FIG. 33 shows cadmium and leached tellurium recovered by each step of the process.

The granulometry x>1 mm provided less losses of solution than the previous tests. However, the results were not markedly different considering the cadmium that remains in the rinsing solutions.

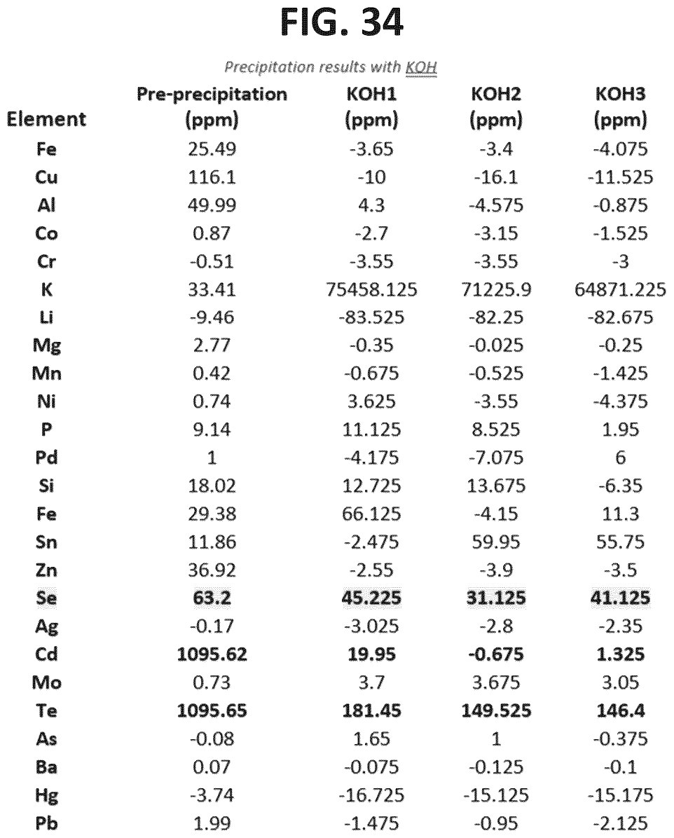

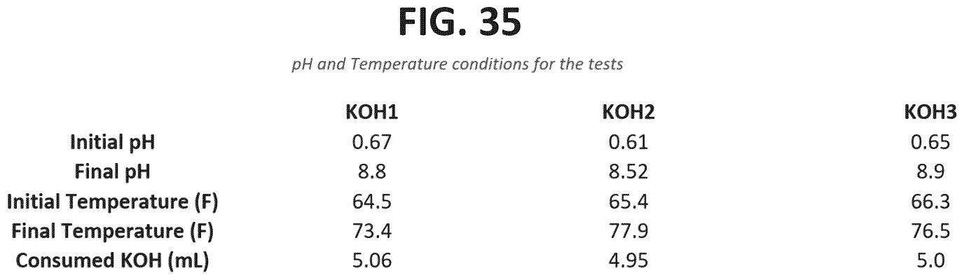

Precipitation trials with KOH 5M are now discussed. For these trials, 20 mL of the piranha solution+rinsing water mixture were precipitated with KOH until pH 8.5-9 and analyzed. The results are presented in the table of FIG. 34. The table of FIG. 35 shows pH and temperature conditions for the KOH precipitation tests.

Also, a second round of precipitation was performed to precipitate the selenium in the sample. For this test, the pH of 10 mL of the mixed samples were adjusted to ten, and two different chemicals were added. The addition of sodium sulfide and sodium hydrosulfite did not precipitate the Selenium in pH 10.

Efforts to test precipitation of Selenium are now discussed. Under normal conditions, the selenium is insoluble in water in the form of sulfide.

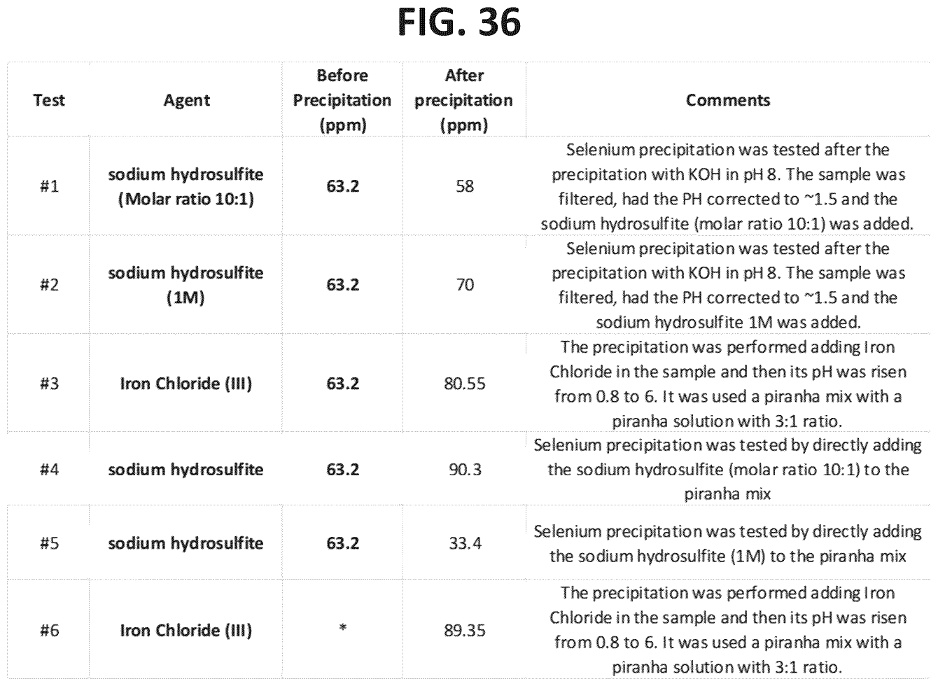

Some experiments with different precipitation agents were performed. The results are summarized in the table of FIG. 36.

FIG. 36 shows test #5 to be an effective selenium precipitation method. Using the sodium hydrosulfite 1M it was possible to precipitate a half of the selenium presented in the original sample.

Coagulant tests are now described. A test with aluminum sulfate was performed to evaluate the form of the precipitate after the precipitation process with KOH. The aluminum sulfate was added to the solution before the precipitation test.

Observation indicated that the aluminum sulfate produced a particle agglomerate that helped the decantation of the precipitate. This process formed a “mud” which still had solution on it-different from precipitation with NaOH without the aluminum sulfate.

Particle size for leaching is defined as follows. Piranha leaching tests were performed with 15- and 20-mm particle size leaching (3:1 H₂SO₄/H₂O₂). To promote the piranha solution reaching the interior of the samples, the glass sheets of the samples were separated.

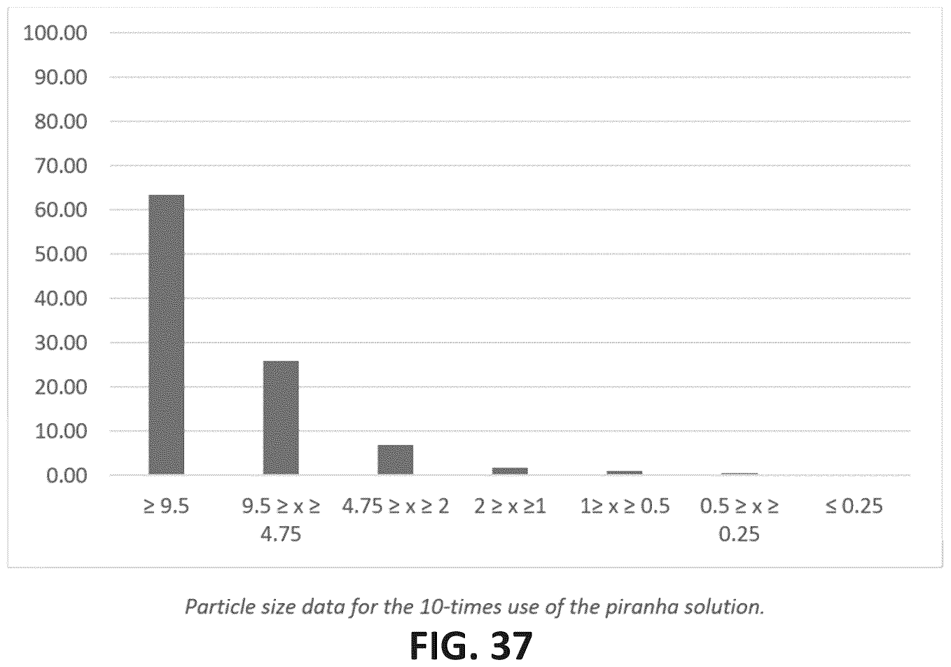

A ten-times use of the piranha solution experiment was performed using the shower apparatus. For this experiment, samples with the Particle Size Distribution (PSD) described in FIG. 37 were leached, rinsed, and analyzed.

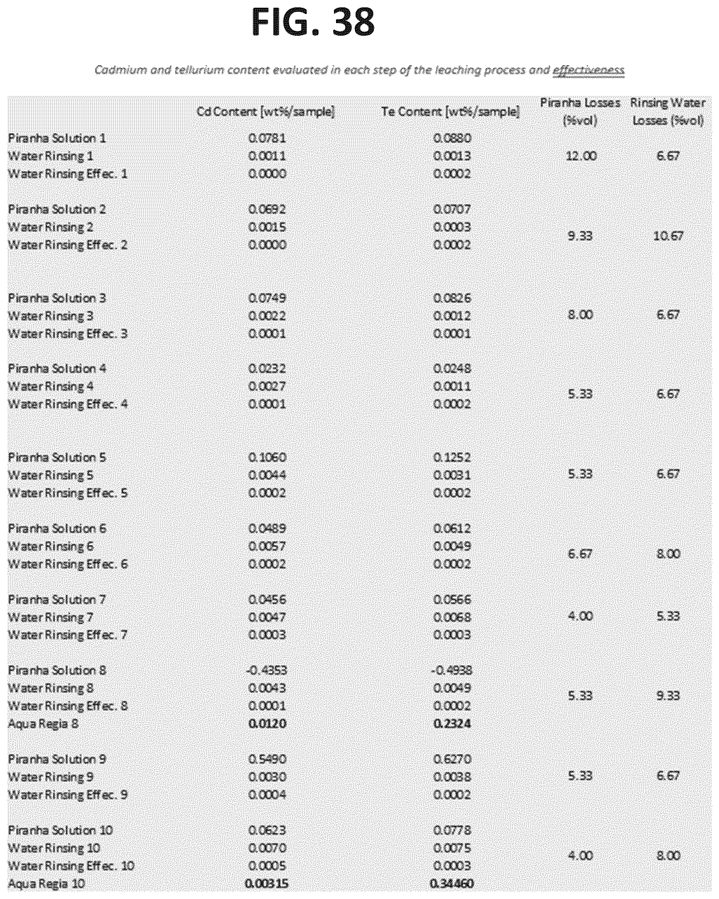

The results are presented in the plot of FIG. 37. There was cadmium left after the tenth use (the aqua regia could remove a fraction of cadmium). The table of FIG. 38 shows Cadmium and tellurium content evaluated in steps of the leaching process and effectiveness

An experiment reducing the quantity of the peroxide in the piranha solution (from 3:1 was reduced to 3:0.25) was also performed. However, the solution did not remove all the cadmium.

Precipitation tests were performed with the goal of measuring the volume and the precipitate, with and without the addition of aluminum sulfate. The same volume of piranha+rinsing mix was used for both samples, and they were precipitated under the same conditions.

The results show that the aluminum sulfate increases both viscosity and volume of the precipitate which may turn it easier to remove in the solid/liquid separation steps. The volume and masses of the dried precipitate are shown in Table 5 below.

| | Volume (wet) | |
|---|---|---|
| Sample | (mL) | Dried Mass (g) |
| piranha/rinsing mix | 25 | 0.5141 |
| piranha/rinsing mix + | 37 | 0.4082 |
| Aluminum Sulfate | | |

Clause 1B. A method comprising: leaching a portion of a used thin film solar module with an acid and a peroxide; and precipitating an element of the used thin film solar module from leachate.
Clause 2B. A method as in Clause 1B wherein the element comprises cadmium.
Clause 3B. A method as in Clause 1B wherein the element comprises tellurium.
Clause 4B. A method as in any of Clauses 1B or 2B wherein the precipitating is caused by a hydroxide.
Clause 5B. A method as in Clause 4B wherein the hydroxide comprises sodium hydroxide and/or potassium hydroxide.
Clause 6B. A method as in any of Clauses 1B, 4B, or 5B wherein the element comprises selenium.
Clause 7B. A method as in any of Clauses 1B, 2B, 3B, 4B, 5B, or 6B wherein the precipitating is caused by sodium hydrosulfite.
Clause 8B. A method as in any of Clauses 1B, 2B, 3B, 4B, 5B, 6B, or 7B wherein the precipitating is caused by sodium sulfide (Na2S) and/or hydrogen sulfide (H2S).
Clause 9B. A method as in any of Clauses 1B, 2B, 3B, 4B, 5B, 6B, 7B, or 8B wherein the portion of the used thin film solar module comprises a shard resulting from mechanical processing.
Clause 10B. A method as in Clause 9B wherein the shard is >1.25 mm.
Clause 11B. A method as in any of Clauses 9B or 10B wherein the mechanical processing removed at least one glass layer.
Clause 12B. A method as in any of Clauses 1B, 2B, 3B, 4B, 5B, 6B, 7B, 8B, 9B, 10B, or 11B wherein the leachate comprises water.
Clause 13B. A method as in any of Clauses 1B, 2B, 3B, 4B, 5B, 6B, 7B, 8B, 9B, 10B, 11B, or 12B wherein the leaching utilizes a shower.
Clause 14B. A method as in any of Clauses 1B, 2B, 3B, 4B, 5B, 6B, 7B, 8B, 9B, 10B, 11B, 12B, or 13B further comprising reusing the leachate after the precipitating.
Clause 15B. A method as in any of Clauses 1B, 2B, 3B, 4B, 5B, 6B, 7B, 8B, 9B, 10B, 11B, 12B, 13B, or 14B wherein the precipitating is caused by a coagulant.
Clause 16B. A method as in any of Clauses 1B, 2B, 3B, 4B, 5B, 6B, 7B, 8B, 9B, 10B, 11B, 12B, 13B, 14B, or 15B further comprising rinsing with water.
Clause 17B. A method as in Clause 16B further comprising reusing rinse water.

Vapor deposition techniques—such as Chemical Vapor Deposition (CVD) and Physical Vapor Deposition (PVD)—may be used in fabricating a photovoltaic module. In order to effect module recycling, embodiments implement processing that allows recovery of a substrate having substantially reduced levels of contamination. This may be accomplished by introducing chemical reactant(s) and/or solvents in the form of fluid(s) to permeate through polymeric layers of module and reach solar module internal layers formed by vapor deposition. The introduction of fluid(s) may be performed under pressure (e.g., within a chamber of an apparatus designed to achieve this effect).

### Example

Solar modules may be fabricated such that the internal layers (e.g., PV and/or other layers formed by vapor deposition) are protected from the outside environment.

In order to achieve this, a series of physical barriers may be disposed between internal layer(s) and external layers.

Such barriers can include, but are not limited to, one or more of:
external glass,
(aluminum) frame,
sealant used to attach the (aluminum) frame,
internal encapsulant(s).

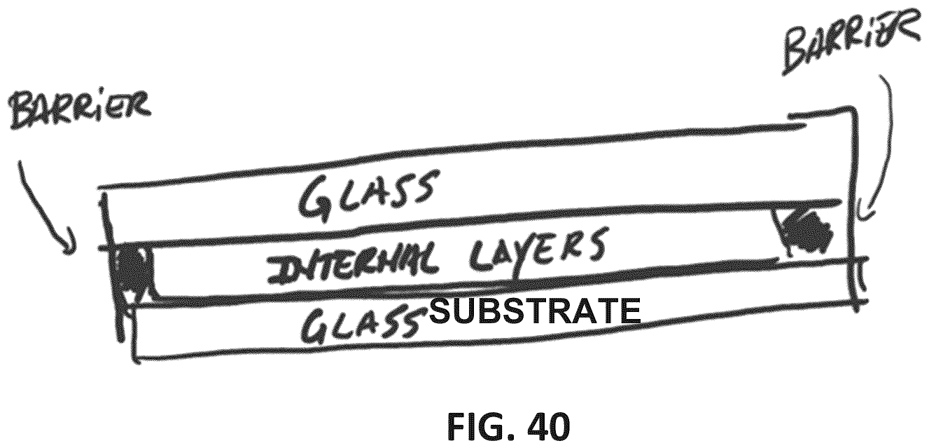

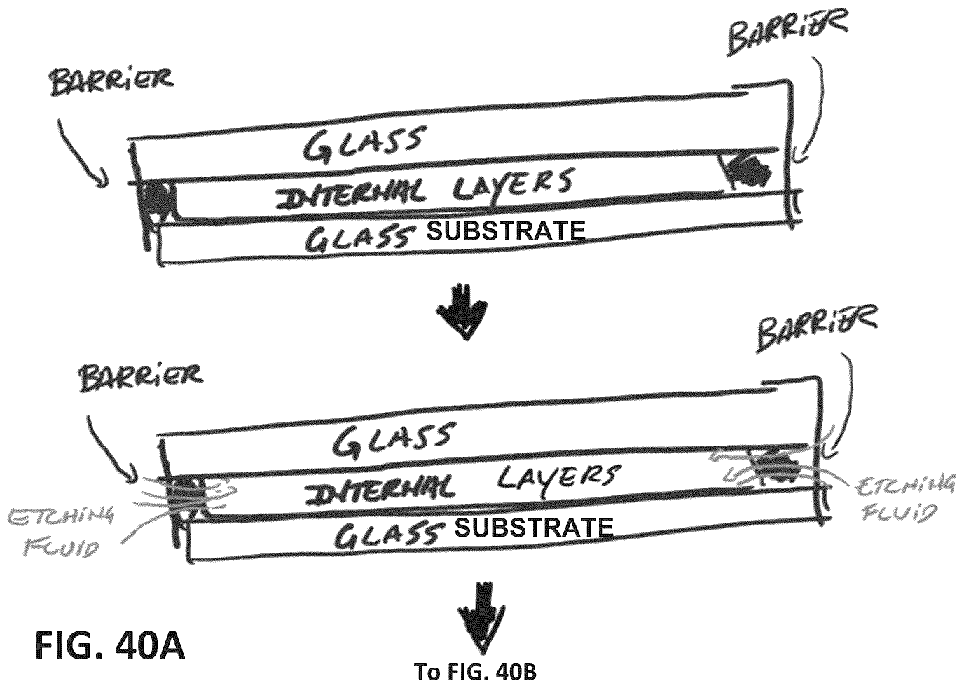

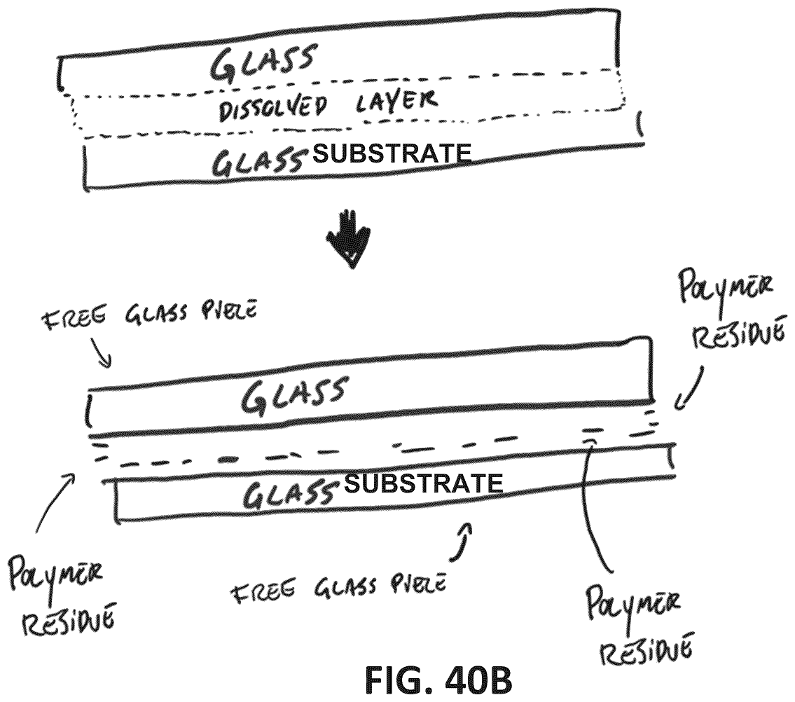

As shown in the simplified cross-section of FIG. 40, if the frame is removed, the laminate may be protected mainly by the glass and the encapsulant. The encapsulant may be formed from polymeric material that is resistant to attack by solvents or reactants (which may be organic and/or inorganic).

During fabrication, vapor deposition leads to the formation of internal layers-such as semiconductor materials such as amorphous silicon (a-Si), cadmium telluride (CdTe), or copper indium gallium selenide (CIGS)-onto the substrate. These thin films can form the active layers of the solar cells.

Vapor deposition may also create other than photovoltaic layers that feature in the operation of the module. Examples can include insulating layers such as oxides and/or nitrides, or conducting materials such as metals, metal alloys, and Transparent Conducting Oxide (TCO).

According to embodiments, recycling of PV modules may be accomplished by using a chamber with high pressure and/or high temperature. This allows solvents and/or reactants to permeate through the polymeric layers and reach the internal layers.

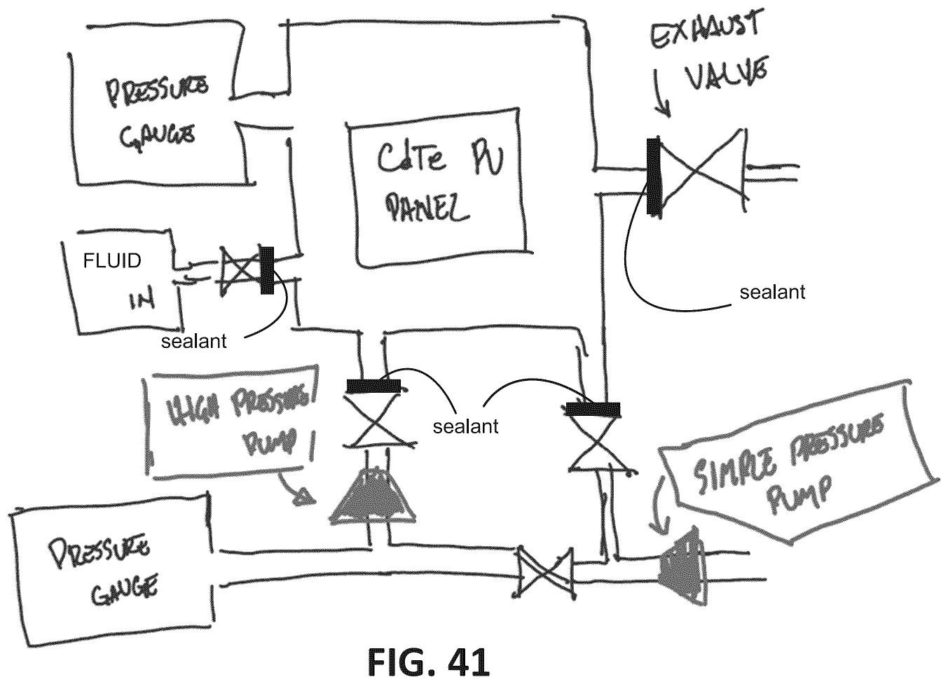

An apparatus such as an autoclave or otherwise sealed container in which chemical(s) for etching, dissolution, and/or degradation (e.g. hydrogen peroxide and/or sulfuric acid) are present and permeate through the barriers (e.g. encapsulant). FIG. 41 shows a simplified view of an embodiment of an apparatus.

The sealant in the apparatus of FIG. 41 may be chosen to withstand high pressure and/or temperature conditions and the aggressive nature of reactant/solvent chemicals that are being used.

The particular apparatus of FIG. 41 represents merely one specific embodiment. According to various embodiments, apparatuses may be designed to implement processing of used solar modules in a batch and/or continuous manner.

High pressures and/or temperatures can increase permeability of fluids through an encapsulant barrier, allowing them to trespass the encapsulant barrier. Fluids in the gas state, liquid state, or both can be introduced to promote permeability.

Selection of appropriate conditions (e.g., pressure, temperature) and chemicals (e.g., reactant(s), solvent(s)) in particular embodiments may take into account the permeability of the encapsulants (barriers). For solar modules, materials used as encapsulants may be consistent across different manufacturers and/or models.

As shown in FIG. 40A, once fluid(s) reach internal layer(s) of a solar module, it may react to remove vapor deposited layer(s)—e.g., by dissolution, degradation, and/or decomposition. Such layers may be present on the surface of the substrate (which can be glass).

As shown in FIG. 40B, this removal of internal vapor deposited layer(s) separates the original laminated sandwich structure into at least two major components. One component includes the substrate on one side of the vapor deposited layer. The other component includes materials on the opposite side of the vapor deposited layer.

In this manner, the original two faces of the laminate now give way to at least four faces. Such layers may be made of glass and polymer(s).

The etched material of the vapor deposited layer (which may be in liquid phase), is purged out of the apparatus through an exhaust valve. Solid material remaining in the chamber can be recovered.

The resulting purged fluid comprising elements of the vapor deposited layer, can be treated with one or more processes. Such processes can include but are not limited to one or more of (in any order):
precipitation,
electrowinning,
column ion exchange,
filtering.

Alone or in combination, these processes can allow enrichment of the thin film elements (e.g., for disposal). And, according to some embodiments the thin film elements can be recovered.

In some embodiments, fluid remaining after these processes can be discarded, or recirculated and used again in another cycle of etching.

It is noted that embodiments are not limited to removing materials that are formed by vapor deposition. Materials formed by other than vapor deposition may also be dissolved, degraded, and/or decomposed by the introduction of fluid(s) according to embodiments. Examples of such materials can include those formed by oxidation, liquid phase deposition (e.g., liquid phase epitaxy), polymerization, curing, and others.

Embodiments as described herein may offer one or more benefits. One possible benefit is efficiency. For example, the delamination and the chemical etching may be accomplished together in a single process and/or apparatus.

Other possible benefits that may be conferred by embodiments, can include but are not limited to one or more of the following.
The recovery of metals downstream of the etching is simplified by having a more concentrated pregnant leaching fluid.
Used solar panels that are broken, may be more susceptible to processing, as each crack represents another path for the fluid to infiltrate the structure of the laminate.
Several panels can be placed inside a single apparatus so that this method can have high throughput in a batch process
Clause 1C. A method comprising:
disposing a used solar module within a chamber, the used solar module comprising a substrate, a vapor deposited layer including an element, and a barrier;
introducing a fluid to the chamber at greater than atmospheric pressure to penetrate the barrier and etch the vapor deposited layer; and
removing a pregnant fluid including the element, from the chamber.
Clause 2C. A method as in Clause 1C wherein the vapor deposited layer is formed by Physical Vapor Deposition (PVD).
Clause 3C. A method as in Clause 1C wherein the vapor deposited layer is formed by Chemical Vapor Deposition (CVD).
Clause 4C. A method as in any of Clauses 1C, 2C, or 3C wherein the vapor deposited layer is a photovoltaic layer.
Clause 5C. A method as in any of Clauses 1C, 2C, 3C, or 4C wherein the vapor deposited layer comprises CdTe.
Clause 6C. A method as in any of Clauses 1C, 2C, 3C, or 4C wherein the vapor deposited layer comprises amorphous silicon.
Clause 7C. A method as in any of Clauses 1C, 2C, 3C, or 4C wherein the vapor deposited layer comprises Copper Indium Gallium Selenide (CIGS).
Clause 8C. A method as in any of Clauses 1C, 2C, 3C, 4C, 5C, or 6C wherein the fluid comprises an organic acid.
Clause 9C. A method as in any of Clauses 1C, 2C, 3C, 4C, 5C, 6C, or 7C wherein the fluid comprises an inorganic acid.
Clause 10C. A method as in Clause 9C wherein the fluid comprises sulfuric acid.
Clause 11C. A method as in any of Clauses 1C, 2C, 3C, 4C, 5C, 6C, 7C, 8C, 9C, or 10C wherein the fluid comprises a peroxide.
Clause 12C. A method as in Clause 11C wherein the peroxide comprises hydrogen peroxide.
Clause 13C. A method as in any of Clauses 1C, 2C, 3C, 4C, 5C, 6C, 7C, 8C, 9C, 10C, 11C, or 12C wherein the fluid comprises gas.
Clause 14C. A method as in any of Clauses 1C, 2C, 3C, 4C, 5C, 6C, 7C, 8C, 9C, 10C, 11C, 12C, or 13C wherein the fluid comprises liquid.
Clause 15C. A method as in any of Clauses 1C, 2C, 3C, 4C, 5C, 6C, 7C, 8C, 9C, 10C, 11C, 12C, 13C, or 14C wherein the fluid comprises solvent.
Clause 16C. A method as in any of Clauses 1C, 2C, 3C, 4C, 5C, 6C, 7C, 8C, 9C, 10C, 11C, 12C, 13C, 14C, or 15C wherein the fluid comprises a reactant.
Clause 17C. A method as in any of Clause 1C, 2C, 3C, 4C, 5C, 6C, 7C, 8C, 9C, 10C, 11C, 12C, 13C, 14C, 15C, or 16C further comprising processing the pregnant fluid to enrich the element.
Clause 18C. A method as in Clause 17C wherein the processing comprises at least one of:
precipitation,
electrowinning,
column ion exchange,
filtering.
Clause 19C. A method as in any of Clauses 1C, 2C, 3C, 4C, 5C, 6C, 7C, 8C, 9C, 10C, 11C, 12C, 13C, 14C, 15C, 16C, 17C, or 18C further comprising recovering the element.
Clause 20C. A method as in any of Clauses 1C, 2C, 3C, 4C, 5C, 6C, 7C, 8C, 9C, 10C, 11C, 12C, 13C, 14C, 15C, 16C, 17C, 18C, or 19C further comprising discarding the element.

It is emphasized that the approaches described above may be utilized alone, or in various combinations to achieve processing of used solar modules for recycling.

What is claimed is:

1. A method comprising:
providing a used solar module comprising,
encapsulant, and
a top glass sheet overlying a photovoltaic layer including an element, formed upon a bottom sheet; and
applying mechanical energy from a hammer to separate the bottom sheet bearing the photovoltaic layer.

2. A method as in claim 1 further comprising changing a temperature of the used solar module prior to applying the mechanical energy.

3. A method as in claim 2 wherein the temperature is increased.

4. A method as in claim 1 wherein the hammer is applied to the bottom sheet.

5. A method as in claim 1 wherein the hammer is a hammer mill.

6. A method as in claim 1 wherein the hammer is a hammer-knife mill.

7. A method as in claim 1 wherein the used solar module comprises at least one of:
Tellurium;
Selenium; and
Zinc.

8. A method as in claim 1 wherein the photovoltaic layer comprises at least one of:
Cadmium;
Tellurium; and
Silicon.

9. A method as in claim 1 wherein the bottom sheet comprises glass.

10. A method as in claim 9 wherein an adhesive force between the bottom sheet and encapsulant of the used solar module keeps the bottom sheet in place during the application 2 of mechanical force.

11. A method as in claim 1 further comprising performing chemical processing to separate the element.

12. A method as in claim 11 wherein the chemical processing comprises leaching.

13. A method as in claim 11 wherein the chemical processing comprises removing a vapor deposited layer of the used solar module.

14. A method as in claim 13 wherein vapor deposited layer comprises Transparent Conducting Oxide (TCO).

15. A method as in claim 1 further comprising performing sieving to separate the element.

16. A method as in claim 1 wherein the mechanical energy imparts a shear force.

17. A method as in claim 16 wherein the shear force is applied at an angle.

18. A method as in claim 1 wherein the mechanical energy comprises mechanical cleaving.

19. A method as in claim 1 wherein the hammer comprises rubber.

20. A method as in claim 1 wherein an adhesive force between the bottom sheet and encapsulant of the used solar module keeps the bottom sheet in place during the application of mechanical force.
